(19) United States
(12) Patent Application Publication
(10) Pub. No.: US 2026/0353134 A1
(43) Pub. Date: Nov. 5, 2026

(54) METHODS FOR WIRELESS DEVICE SIDED SPATIAL BEAM PREDICTIONS

(71) Applicant: Telefonaktiebolaget LM Ericsson (publ), Stockholm (SE)

(72) Inventors: Mattias FRENNE, Uppsala (SE); Andreas NILSSON, Göteborg (SE); Jingya LI, Göteborg (SE); Roy TIMO, Kungsängen (SE); Icaro Leonardo DA SILVA, Solna (SE); Henrik RYDÉN, Stockholm (SE)

(21) Appl. No.: 19/101,722

(22) PCT Filed: Aug. 11, 2023
(86) PCT No.: PCT/SE2023/050812

§ 371 Date: Feb. 6, 2025

Related U.S. Application Data
(60) Provisional application No. 63/397,455, filed on Aug. 12, 2022.

(51) Int. Cl. H04W 24/10

(52) U.S. Cl. CPC H04W 24/10

(57) ABSTRACT

A wireless device (WD) is described. The WD is configured to receive a downlink (DL) RS configuration for configuring two or more sets of reference signal resources, receive a CSI report configuration and a first message requesting the WD to measure on a subset of DL RSs of a first set of DL RSs associated with the first set of beams, and perform measurements on a subset of DL RSs of a second set of DL RSs. The WD is further configured to perform one or more actions associated with an artificial intelligence model using at least the measurements on the subset of DL RSs of the second set of DL RSs, predict one or more DL RSs from the first set of DL RSs based in part on the one or more actions, and transmit information about the predicted one or more RSs.

### TECHNICAL FIELD

The present disclosure relates to wireless communications, and in particular, to prediction of a beam among a set of fixed beams (“F beams”).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### Beam Management

### Beam Management Procedure

In frequency range 2 (FR2), multiple radio frequency (RF) beams may be used to transmit and receive signals at a network node and a wireless device. For each downlink (DL) beam from a network node, there is typically an associated best wireless device receiving (Rx) beam for receiving signals from the DL beam. The DL beam and the associated wireless device Rx beam forms a beam pair. The beam pair can be identified through a so-called beam management process in new radio (NR).

A DL beam is (typically) identified by an associated DL reference signal (RS) transmitted in the beam. The RS can be transmitted periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the wireless device can determine and report to the network node the best DL beam to use for DL transmissions. The network node can then transmit a burst of DL-RS in the reported best DL beam to let the wireless device evaluate candidate wireless device Rx beams.

Although not explicitly stated in the 3GPP NR specification, beam management has been divided into three procedures, schematically illustrated in the example of FIG. 1:

P-1 Procedure: Purpose is to find a coarse direction for the wireless device using wide network node transmission (TX) beam covering the whole angular sector.

P-2 Procedure: Purpose is to refine the network node TX beam by doing a new beam search around the coarse direction found in P1.

P-3 Procedure: Used for wireless devices that have analog beamforming to let them find a suitable wireless device RX beam.

The P-1 Procedure is expected to utilize beams with rather large beamwidths and where the beam RSs are transmitted periodically and are shared between all wireless devices of the cell (cell specific RS transmissions). Typically, RSs for the P-1 Procedure are periodic channel state information reference signal (CSI-RS) or synchronization signal block (SSB). The wireless device then reports the N best beams to the network node and their corresponding reference signal strength indicator (RSRP) values.

The P-2 Procedure is expected to use aperiodic/or semi-persistent CSI-RS transmitted in narrow beams around the coarse direction found in the P-1 Procedure. These RSs are configured in a wireless device-specific manner (not shared by many wireless devices).

The P-3 Procedure is expected to use aperiodic or semi-persistent CSI-RSs repeatedly transmitted in one narrow network node beam. One alternative way is to let the wireless device determine a suitable wireless device RX beam based on the periodic SSB transmission. Since each SSB consists of four optical frequency division multiplex (OFDM) symbols, a maximum of four wireless device RX beams can be evaluated during each SSB burst transmission. One benefit of using SSB instead of CSI-RS is that no extra overhead of CSI-RS transmission is needed.

### Beam Indication

In NR, several signals can be transmitted from different antenna ports of the same network node. These signals can have the same large-scale properties such as Doppler shift/spread, average delay spread, or average delay. These antenna ports are then said to be quasi co-located (QCL).

If the wireless device knows that two antenna ports are QCL with respect to a certain parameter (e.g., Doppler spread), the wireless device can estimate that parameter based on one of the antenna ports and apply that estimate for receiving signal on the other antenna port.

For example, there may be a QCL relation between a CSI-RS for tracking RS (TRS) and the physical downlink shared channel (PDSCH) demodulation reference signal (DMRS). When wireless device receives the PDSCH DMRS it can use the measurements already made on the timing reference signal (TRS) to assist the DMRS reception.

Information about what assumptions can be made regarding QCL is signaled to the wireless device from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is referred to as spatial QCL. There is currently no strict definition of spatial QCL, but the understanding is that if two transmitted antenna ports are spatially QCL, the wireless device can use the same Rx beam to receive them. This is helpful for a wireless device that uses analog beamforming to receive signals, since the wireless device needs to adjust its RX beam in some direction prior to receiving a certain signal. If the wireless device knows that the signal is spatially QCL with some other signal it has received earlier, then it can safely use the same RX beam to receive also this signal.

In NR, the spatial QCL relation for a DL or UL signal/channel can be indicated to the wireless device by using a “beam indication”. The “beam indication” is used to help the wireless device to find a suitable RX beam for DL reception, and/or a suitable TX beam for UL transmission. In NR, the “beam indication” for DL is conveyed to the wireless device by indicating a transmission configuration indicator (TCI) state to the wireless device, while in UL the “beam indication” can be conveyed by indicating a DL-RS or UL-RS as spatial relation (in NR Rel-15/16, i.e., 3GPP Rel-15/16) or a TCI state (in 3GPP NR Rel-17).

Beam Management with Unified TCI Framework

In NR, downlink beam management is performed by conveying spatial QCL (‘Type D’) assumptions to the wireless device through TCI states.

In 3GPP NR Rel-15 or Rel-16:
For physical downlink control channel (PDCCH): The network (NW) and/or network node configures the wireless device with a set of PDCCH TCI states by radio resource control (RRC), and then activates one TCI state per control resource set (CORESET) using medium access control (MAC) control element (CE).
For physical downlink shared channel (PDSCH): The NW and/or network node configures the wireless device with a set of PDSCH TCI states by RRC, and then activates up to 8 TCI states by MAC CE. After activation, the NW and/or network node dynamically indicates one of these activated TCI states using a TCI field in downlink control information (DCI) when scheduling PDSCH.

Such a framework allows great flexibility for the network to instruct the wireless device to receive signals from different spatial directions in DL with a cost of large signaling overhead and slow beam switch. These limitations are particularly noticeable and costly when wireless device movement is considered. One example is that beam update using DCI can only be performed for PDSCH, and MAC-CE and/or RRC is required to update the beam for other reference signals/channels, with cause extra overhead and latency.

Furthermore, in the majority of cases, the network transmits to and receive from a wireless device in the same direction for both data and control. Hence, using separate framework (TCI state respective spatial relations) for different channels/signals complicates the implementations.

In 3GPP Rel-17, a common beam framework was introduced for beam management in FR2, in which a common beam represent by a TCI state may be activated/indicated to a wireless device and the common beam is applicable for multiple channels/signals such as PDCCH and PDSCH. The common beam framework is also referred to as a unified TCI state framework.

The new framework can be RRC configured in one out two modes of operation, i.e., “Joint DL/UL TCI” or “Separate DL/UL TCI.” For “Joint DL/UL TCI,”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state can be updated in a similar way as the TCI state update for PDSCH in Rel-15/16, i.e., with one of two alternatives:
Two-stage: RRC signaling is used to configure a number of unified TCI states in higher layer parameter PDSCH-config, and a MAC-CE is used to activate one of unified TCI states.
Three-stage: RRC signaling is used to configure a number of unified TCI states in PDSCH-config, a MAC-CE is used to activate up to 8 unified TCI states, and a 3-bit TCI state bitfield in DCI is used to indicate one of the activate unified TCI states

The one activated or indicated unified TCI state will be used in subsequent both PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, acknowledgement/negative-acknowledgement (ACK/NACK) of the PDSCH can be used as indication of successful reception of beam indication. For DCI formats 1_1 and 1_2 without DL assignment, a new ACK/NACK mechanism analogous to that for SPS PDSCH release with both type-1 and type-2 hybrid automatic repeat request acknowledgement (HARQ-ACK) codebook is used, where upon a successful reception of the beam indication DCI, the wireless device reports an acknowledgement (ACK).

For DCI-based beam indication, the first slot to apply the indicated TCI is at least Y symbols after the last symbol of the acknowledgment of the joint or separate DL/UL beam indication. The Y symbols are configured by the network node based on wireless device capability, which is also reported in units of symbols. The values of Y are yet not determined and is left to Radio Access Network 4 (RAN4) to decide.

### Reference Signal

### Reference Signal Configurations

### CSI-RS:

A CSI-RS is transmitted over each transmit (Tx) antenna port at the network node and for different antenna ports. The CSI-RS are multiplexed in time, frequency, and code domain such that the channel between each Tx antenna port at the network node and each receive antenna port at a wireless device can be measured by the wireless device. The time-frequency resource used for transmitting CSI-RS is referred to as a CSI-RS resource.

In NR, the CSI-RS for beam management is defined as a 1- or 2-port CSI-RS resource in a CSI-RS resource set where the filed repetition is present. The following three types of CSI-RS transmissions are supported:
Periodic CSI-RS: CSI-RS is transmitted periodically in certain slots. This CSI-RS transmission is semi-statically configured using RRC signaling with parameters such as CSI-RS resource, periodicity, and slot offset.
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission.
Aperiodic CSI-RS: This is a one-shot CSI-RS transmission that can happen in any slot. Here, one-shot means that CSI-RS transmission only happens once per trigger. The CSI-RS resources (i.e., the RE locations which consist of subcarrier locations and OFDM symbol locations) for aperiodic CSI-RS are semi-statically configured. The transmission of aperiodic CSI-RS is triggered by dynamic signaling through PDCCH using the CSI request field in UL DCI, in the same DCI where the UL resources for the measurement report are scheduled. Multiple aperiodic CSI-RS resources can be included in a CSI-RS resource set and the triggering of aperiodic CSI-RS is on a resource set basis.

### SSB:

In NR, an SSB consists of a pair of synchronization signals (SSs), physical broadcast channel (PBCH), and DMRS for PBCH. A SSB is mapped to 4 consecutive OFDM symbols in the time domain and 240 contiguous subcarriers (20 RBs) in the frequency domain.

To support beamforming and beam-sweeping for SSB transmission, in NR, a cell can transmit multiple SSBs in different narrow-beams in a time multiplexed fashion. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame may depend on network implementation. The SSBs within a half frame are broadcasted periodically from each cell. The periodicity of the half frames with SS/PBCH blocks is referred to as SSB periodicity, which is indicated by SIB1.

The maximum number of SSBs within a half frame, denoted by L, depends on the frequency band, and the time locations for these L candidate SSBs within a half frame depends on the SCS of the SSBs. The L candidate SSBs within a half frame are indexed in an ascending order in time from 0 to L−1. By successfully detecting PBCH and its associated DMRS, a wireless device knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission.

### Measurement Resource Configurations

In NR, a wireless device can be configured with N≥1 CSI reporting settings (i.e., CSI-ReportConfig), M≥1 resource settings (i.e., CSI-ResourceConfig), where each CSI reporting setting is linked to one or more resource setting for channel and/or interference measurement. The CSI framework is modular, meaning that several CSI reporting settings may be associated with the same Resource Setting.

The measurement resource configurations for beam management are provided to the wireless device by RRC information elements (IEs) CSI-ResourceConfigs. One CSI-ResourceConfig contains several non-zero power (NZP)-CSI-RS-ResourceSets and/or CSI-SSB-ResourceSets.

A wireless device can be configured to perform measurement on CSI-RSs. Here the RRC information element (IE) NZP-CSI-RS-ResourceSet is used. A NZP CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources can be grouped to an NZP-CSI-RS-ResourceSet. A wireless device can also be configured to perform measurements on SSBs. Here, the RRC IE CSI-SSB-ResourceSet is used. Resource sets including SSB resources are defined in a similar manner.

In the case of aperiodic CSI-RS and/or aperiodic CSI reporting, the network node configures the wireless device with S_c CSI triggering states. Each triggering state contains the aperiodic CSI report setting to be triggered along with the associated aperiodic CSI-RS resource sets.

Periodic and semi-persistent Resource Settings may only include a single resource set (i.e., S=1) while S>=1 for aperiodic Resource Settings. This is because in the aperiodic case, one out of the S resource sets included in the Resource Setting is indicated by the aperiodic triggering state that triggers a CSI report.

### Measurement Reporting

Three types of CSI reporting are supported in NR as follows:
Periodic CSI Reporting on physical uplink control channel (PUCCH): CSI is reported periodically by a wireless device. Parameters such as periodicity and slot offset are configured semi-statically by higher layer RRC signaling from the network node to the wireless device.
Semi-Persistent CSI Reporting on physical uplink shared channel (PUSCH) or PUCCH: similar to periodic CSI reporting, semi-persistent CSI reporting has a periodicity and slot offset which may be semi-statically configured. However, a dynamic trigger from network node to wireless device may be needed to allow the wireless device to begin semi-persistent CSI reporting. A dynamic trigger from network node to wireless device is needed to request the wireless device to stop the semi-persistent CSI reporting.
Aperiodic CSI Reporting on PUSCH: This type of CSI reporting involves a single-shot (i.e., one time) CSI report by a wireless device which is dynamically triggered by the network node using DCI. Some of the parameters related to the configuration of the aperiodic CSI report is semi-statically configured by RRC but the triggering is dynamic.

In each CSI reporting setting, the content and time-domain behavior of the report is defined, along with the linkage to the associated Resource Settings. The CSI-ReportConfig IE include the following configurations:
reportConfigType
   Defines the time-domain behavior, i.e., periodic CSI reporting, semi-persistent CSI reporting, or aperiodic CSI reporting, along with the periodicity and slot offset of the report for periodic CSI reporting.
reportQuantity
   Defines the reported CSI parameter(s) (i.e., the CSI content), such as PMI, CQI, RI, LI (layer indicator), CRI (CSI-RS resource index) and L1-RSRP. Only a certain number of combinations are possible (e.g., ‘cri-RI-PMI-CQI’ is one possible value and ‘cri-RSRP’ is another) and each value of reportQuantity may correspond to a certain CSI mode.
codebookConfig
   Defines the codebook used for PMI reporting, along with possible codebook subset restriction (CBSR). Two “Types” of PMI codebook are defined in NR, Type I CSI and Type II CSI, each codebook type further has two variants each.
reportFrequencyConfiguration
   Define the frequency granularity of PMI and CQI (wideband or subband), if reported, along with the CSI reporting band, which is a subset of subbands of the bandwidth part (BWP) which the CSI corresponds to.
Measurement restriction in time domain (ON/OFF) for channel and interference respectively

For beam management, a wireless device can be configured to report L1-RSRP for up to four different CSI-RS/SSB resource indicators. The reported RSRP value corresponding to the first (best) CSI reference signal resource indicator (CRI) and/or SSB resource indicator (RI) requires 7 bits, using absolute values, while the others require 4 bits using encoding relative to the first. In NR release 16, the report of L1 signal to interference and noise ratio (L1-SINR) for beam management has already been supported.

### Beam Prediction

One example artificial intelligence (AI)/machine-learning (ML)-model currently discussed in the AI for air-interface 3GPP Rel-18 includes predicting the channel in respect to a beam for a certain time-frequency resource. The expected performance of such prediction depends on several different aspects, for example time/frequency variation of channel due to wireless device mobility or changes in the environment. Due to the inherit correlation in time, frequency and the spatial domain of the channel, an ML-model can be trained to exploit such correlations. The spatial domain can include different beams, where the correlation properties partly depend on the how the network node antennas forms the different beams, and how wireless device forms the receiver beams.

The device can use such prediction ML-model to reduce its measurement related to beamforming. In NR, one can request a device to measure on a set of SSB beams or/and CSI-RS beams. A stationary device typically experiences less variations in beam quality in comparison to a moving device. The stationary device can therefore save battery and reduce the number of beam measurements by instead using an ML model to predict the beam quality without an explicit measurement. It can do this, for example, by measuring a subset of the beams and predicting the rest of the beams. An AI measure on a subset of beams may be used to predict the best beam, which can reduce up to 75% measurement time.

In one existing system, a method is described for enabling a wireless device to predict future beam values based on historical values. Based on received device data from measurement reports, the network/network node can learn, for example, which sequences of signal quality measurements (e.g., RSRP measurements) lead to large signal quality drop events (e.g., turning around the corners in FIG. 2, discussed below). This learning procedure can be enabled, for example, by dividing periodically reported RSRP data into a training and prediction window.

In the example shown in FIG. 2, two devices move and turn around the same corner. Device 120b, marked by dashed line, is the first to turn around the corner and experience a large signal quality drop. The idea is to mitigate the drop of a second device (120a) by learning from the first device's experiences.

The learning can be performed by feeding RSRP in t1, . . . , tn into a machine learning model (e.g., neural network), and then learn the RSRP in tn+1, tn+2. After the model is trained, the network can then predict future signal quality values, the signal quality prediction can then be used to avoid radio-link failure, or beam failure, by:
Initiate inter-frequency handover
Set handover/reselection parameters
Pre-emptively perform candidate beam selection to avoid beam failure
Change device scheduler priority, for example schedule device when the expected signal quality is good or meets a predefined threshold.

### 3GPP Considerations

The 3GPP has considered studying AI/ML based spatial beam prediction for a set A of beams based on measurement results of Set B of beams. The Set B of beams could either be a subset of the Set A of beams, or the set A of beams could consist of different beams compared to the Set B of beams (for example Set A consists of narrow beams and Set B consists of wide beams). The spatial beam prediction could either be made on the network node side or at the wireless device side.

With the introduction of new features at every release the amount of CSI measurements the wireless device is configured to perform, and the CSI report size is increasing more and more compared to existing system and/or 3GPP standards, which is a first problem.

With deployment in higher frequencies, as in 5G NR, this number is even higher as the wireless device is configured to perform measurements on resources (DL RSs e.g., SSBs and/or CSI-RSs) transmitted in multiple spatial domain directions (e.g., DL RSs transmitting using spatial domain filters and/or multiple input multiple output (MIMO) precoding vectors) which may be referred to as DL beams or beams transmitted by the network/network node.

Having to perform more CSI measurements increases the wireless device energy consumption which is a second problem.

If these measurements are based on DL RSs the network/network node transmits primarily for that purpose and for a particular wireless device (e.g., CSI-RSs for beam measurements), that may represent an increased overhead in network transmissions when more wireless devices are served by the cell, and also additional interference which is the third and fourth problem.

In addition, more DL RSs/beams to be measured may lead to an increased delay in performing CSI measurements which may lead to delay in making CSI measurements available for being reported, which is a fifth problem.

Longer delays to make CSI measurements available may lead to a risk of failure in the connection, such as beam failure detection (BFD) and/or Radio Link Failure (RLF) as the wireless device may be trying to report to then network/network node that the current beam (e.g., the DL RS associated to the currently activated TCI State) has poor quality or that there is a much better beam (e.g., another DL RS associated to another TCI State) available, so that if that takes too long, it may be too late for the network/network node to trigger a beam switching command (e.g., medium access control (MAC) control element (CE) indicating a new TCI state to be activated), so a failure may occur.

Prediction of beams by the wireless device requires that the wireless device implicitly assumes that the network/network node use a set of F fixed beams (fixed beam patterns, pointing directions, power, etc.) (F beams refers to the number of fixed beams), and that the wireless device tries to use measurements to forecast which of the F beams is the preferred one (e.g., highest receive SNR), without measuring the associated DL RS in all F beams. Thereby some problems with existing systems are partly resolved. This is one reason 3GPP is discussing spatial domain beam prediction using AI/ML.

A problem with spatial domain beam prediction is that the AI/ML model in the wireless device needs to have information about all F beams, such as the beam pattern, etc. Otherwise, the ML model cannot predict a preferred beam among the F since it is only measuring on other/fewer beams. It has been proposed in 3GPP that the network should signal the information on all its F beams to the wireless device, e.g., the beam radiation pattern for each of its F beams. A drawback with this method is that it considers beam information seen from the transmitter perspective, but it does not take into account the effects of the radio channel (scattering, etc.).

This is also a problem since beam patterns may be network site specific, and subject to individual site tuning such as cell planning, etc. Moreover, the information about the beams a network node is using may be proprietary information, and it is not likely network vendors are willing to share this openly.

Therefore, the existing system and proposals suffer from various issues.

### SUMMARY

Some embodiments advantageously provide methods, systems, and apparatuses for prediction of a preferred beam among F beams.

One problem in existing systems is how the wireless device can perform prediction of a preferred beam among F beams based on receiver measurements on fewer or other transmitted network beams without the need for the network/network node to disclose proprietary information of its used F beams.

One or more embodiments in accordance with the present disclosure is to provide the DL RS opportunities so that the wireless device can intermittently measure all F beams (Set A of DL RS). The ML algorithm then obtains as input a “definition” of all F beams (set A) and moreover, these are defined as the wireless device receives it (as opposed to the existing systems where F beams were defined using beam radiation patterns, etc.). The ML algorithm also use as an input measurements of a different set of beams (Set B), which may be a subset of A. Based on set A (seldom received but full F beams) and set B (received frequently), the wireless device ML algorithm can frequently perform a prediction of a preferred beam in Set A without the need to measure all F beams in set A frequently.

According to one aspect, a wireless device (WD) is described. The WD is configured to communicate with a network node and to predict at least reference signals (RSs) associated with the network node. The WD is configured to receive a downlink (DL) RS configuration for configuring two or more sets of reference signal resources. The DL RS configuration includes a first configuration for a first set of beams and a second configuration for a second set of beams. The second set of beams is a subset of the first set of beams. The WD is configured to receive a CSI report configuration associated with the DL reference signal configuration, receive a first message requesting the WD to measure, according to the CSI report configuration, on a subset of DL RSs of a first set of DL RSs associated with the first set of beams, and perform measurements on a subset of DL RSs of a second set of DL RSs associated with the second set of beams. The WD is further configured to perform one or more actions associated with an artificial intelligence model using at least the measurements on the subset of DL RSs of the second set of DL RSs, predict one or more DL RSs from the first set of DL RSs associated with the first set of beams based in part on the one or more actions, and transmit, to the network node, information about the predicted one or more RSs.

In some embodiments, the WD is further configured to receive a second message requesting the WD to measure the first set of DL RSs. The first set of DL RSs is transmitted less often than the second set of DL RSs.

In some other embodiments, the WD is further configured to perform collection of data associated with performance of the prediction of the one or more DL RSs from the first set of DL RSs based on measurements on the second set of DL RSs.

In some embodiments, the WD is further configured to transmit, to the network node, a capability indication indicating one or more of: prediction support; support for a spatial predicted beam report for predicting one or both of beams from the first set of beams and reference signals from the first set of RSs; a first maximum number of one or both of beams of the first set of beams and DL RSs of the first set of DL RS; a second maximum number of one or both of beams of the second set of beams and DL RSs of the second set of DL RS; a minimum number of one or both of beams of the second set of beams and DL RSs of the second set of DL RS; a machine learning, ML, model processing capability associated with the artificial intelligence model; and prediction performance for one or more combinations of the first set of DL RSs and the second set of DL RSS.

In some other embodiments, the WD is further configured to transmit, to the network node, a third message including uplink (UL) assistance information. The UL assistance information includes one or more of WD location information, an estimate of one or both of WD velocity and WD rotation, information about WD antenna panels, and information about WD antenna panels configuration usage.

In some embodiments, the DL RS configuration includes two CSI-RS resource sets, the two CSI-RS resource sets including a first CSI-RS resource set having M CSI-RS resources associated with the first set of beams and a second CSI-RS resource set having N CSI-RS resources associated with the second set of beams.

In some other embodiments, one or more of the second CSI-RS resource set is a subset of the first CSI-RS resource set; the first CSI-RS resource set and the second CSI-RS resource set are linked via a link, where the link indicates that a same beam from the network node is to be used for a CSI-RS resource when the CSI-RS resource is transmitted as part of the first CSI-RS resource set as when the CSI-RS resource is transmitted as part of the second CSI-RS resource set; the link is explicitly configured per CSI-RS resource set; and the link is configured by field in the CSI report configuration.

In some embodiments, one or more of the CSI report configuration includes two report settings, where each report setting points at one CSI-RS resource set each, a parameter is configured per report setting, and when the two report settings are configured with the same parameter, the two CSI-RS resource sets associated with the two report settings are assumed to be linked together; the link is explicitly configured in one resource setting; an explicit indication links the two CSI-RS resource sets together; the CSI-RS resource in the first CSI-RS resource set and the CSI-RS resource in the second CSI-RS resource set is one of the same CSI-RS resource and a different CSI-RS resource; the link of two CSI-RS resources is explicitly configured per CSI-RS resource; the link of two CSI-RS resources is explicitly configured explicitly configured in a table; the link of two CSI-RS resources is dynamically indicated; and the first and second CSI-RS resource set have one of the same time domain behavior and different time domain behavior.

In some other embodiments, the DL RS configuration includes a first single CSI-RS resource set having M CSI-RS resources associated with the first set of beams or a second single CSI-RS resource set having N CSI-RS resources associated with the second set of beams, and one or both of: (A) the CSI report configuration indicates CSI-RS resources in the CSI-RS resource set the WD is to measure; and (B) DL RS configuration indicates which CSI-RS resources in the CSI-RS resource set the WD is to measure.

In some embodiments, the WD is further configured to receive beam assistance information indicating a spatial correlation and a quasi co-collocation (QCL) relation between one or more of beams of the first set of beams, where the beam assistance information is usable as an input to the artificial intelligence model.

In some other embodiments, the WD is further configured to predict one or more set of beams from the first set of beams based in part on the one or more actions and transmit, to the network node, information about the predicted one or more sets of beams.

In some embodiments, the one or more actions include one or more of training the artificial model, retraining the artificial model, and updating the artificial model.

According to another aspect, a method in a wireless device (WD) is described. The WD is configured to communicate with a network node and to predict at least reference signals (RSs) associated with the network node. The method includes receiving a downlink (DL) RS configuration for configuring two or more sets of reference signal resources. The DL RS configuration includes a first configuration for a first set of beams and a second configuration for a second set of beams. The second set of beams is a subset of the first set of beams. The method further includes receiving a CSI report configuration associated with the DL reference signal configuration, receiving a first message requesting the WD to measure, according to the CSI report configuration, on a subset of DL RSs of a first set of DL RSs associated with the first set of beams, and performing measurements on a subset of DL RSs of a second set of DL RSs associated with the second set of beams. The method further includes performing one or more actions associated with an artificial intelligence model using at least the measurements on the subset of DL RSs of the second set of DL RSs, predicting one or more DL RSs from the first set of DL RSs associated with the first set of beams based in part on the one or more actions, and transmitting, to the network node, information about the predicted one or more RSs.

In some embodiments, the method further includes receiving a second message requesting the WD to measure the first set of DL RSs. The first set of DL RSs is transmitted less often than the second set of DL RSs.

In some other embodiments, the method further includes performing collection of data associated with performance of the prediction of the one or more DL RSs from the first set of DL RSs based on measurements on the second set of DL RSs.

In some embodiments, the method further includes transmitting, to the network node, a capability indication indicating one or more of: prediction support; support for a spatial predicted beam report for predicting one or both of beams from the first set of beams and reference signals from the first set of RSs; a first maximum number of one or both of beams of the first set of beams and DL RSs of the first set of DL RS; a second maximum number of one or both of beams of the second set of beams and DL RSs of the second set of DL RS; a minimum number of one or both of beams of the second set of beams and DL RSs of the second set of DL RS; a machine learning, ML, model processing capability associated with the artificial intelligence model; and prediction performance for one or more combinations of the first set of DL RSs and the second set of DL RSS.

In some other embodiments, the method further includes transmitting, to the network node, a third message including uplink (UL) assistance information. The UL assistance information includes one or more of WD location information, an estimate of one or both of WD velocity and WD rotation, information about WD antenna panels, and information about WD antenna panels configuration usage.

In some embodiments, the DL RS configuration includes two CSI-RS resource sets, the two CSI-RS resource sets including a first CSI-RS resource set having M CSI-RS resources associated with the first set of beams and a second CSI-RS resource set having N CSI-RS resources associated with the second set of beams.

In some other embodiments, one or more of the second CSI-RS resource set is a subset of the first CSI-RS resource set; the first CSI-RS resource set and the second CSI-RS resource set are linked via a link, where the link indicates that a same beam from the network node is to be used for a CSI-RS resource when the CSI-RS resource is transmitted as part of the first CSI-RS resource set as when the CSI-RS resource is transmitted as part of the second CSI-RS resource set; the link is explicitly configured per CSI-RS resource set; and the link is configured by field in the CSI report configuration.

In some embodiments, one or more of the CSI report configuration includes two report settings, where each report setting points at one CSI-RS resource set each, a parameter is configured per report setting, and when the two report settings are configured with the same parameter, the two CSI-RS resource sets associated with the two report settings are assumed to be linked together; the link is explicitly configured in one resource setting; an explicit indication links the two CSI-RS resource sets together; the CSI-RS resource in the first CSI-RS resource set and the CSI-RS resource in the second CSI-RS resource set is one of the same CSI-RS resource and a different CSI-RS resource; the link of two CSI-RS resources is explicitly configured per CSI-RS resource; the link of two CSI-RS resources is explicitly configured explicitly configured in a table; the link of two CSI-RS resources is dynamically indicated; and the first and second CSI-RS resource set have one of the same time domain behavior and different time domain behavior.

In some other embodiments, the DL RS configuration includes a first single CSI-RS resource set having M CSI-RS resources associated with the first set of beams or a second single CSI-RS resource set having N CSI-RS resources associated with the second set of beams, and one or both of: (A) the CSI report configuration indicates CSI-RS resources in the CSI-RS resource set the WD is to measure; and (B) DL RS configuration indicates which CSI-RS resources in the CSI-RS resource set the WD is to measure.

In some embodiments, the method further includes receiving beam assistance information indicating a spatial correlation and a quasi co-collocation (QCL) relation between one or more of beams of the first set of beams, where the beam assistance information is usable as an input to the artificial intelligence model.

In some other embodiments, the method further includes predicting one or more set of beams from the first set of beams based in part on the one or more actions and transmitting, to the network node, information about the predicted one or more sets of beams.

In some embodiments, the one or more actions include one or more of training the artificial model, retraining the artificial model, and updating the artificial model.

According to one aspect, a network node is described. The network node is configured to communicate with a wireless device (WD) configured to predict at least reference signals (RSs) associated with the network node. The network node is configured to transmit a downlink (DL) RS configuration for configuring two or more sets of reference signal resources. The DL RS configuration includes a first configuration for a first set of beams and a second configuration for a second set of beams. The second set of beams is a subset of the first set of beams. The network node is further configured to transmit a CSI report configuration associated with the DL reference signal configuration and transmit a first message requesting the WD to measure, according to the CSI report configuration, on a subset of DL RSs of a first set of DL RSs associated with the first set of beams. The WD is also configured to receive, from the WD, information about the one or more RSs that are predicted from the first set of DL RSs associated with the first set of beams based in part on one or more WD actions. The one or more WD actions are associated with an artificial intelligence model and are performed using at least measurements on the subset of DL RSs of the second set of DL RSs. One or more network node actions are performed based on the information about the one or more RSs that are predicted from the first set of DL RSs.

In some embodiments, the network node is further configured to transmit a second message requesting the WD to measure the first set of DL RSs, where the first set of DL RSs are transmitted less often than the second set of DL RSs.

In some other embodiments, the network node is further configured to receive, from the WD, a capability indication. The capability indication indicates one or more of prediction support; support for a spatial predicted beam report for predicting one or both of beams from the first set of beams and reference signals from the first set of RSs; a first maximum number of one or both of beams of the first set of beams and DL RSs of the first set of DL RS; a second maximum number of one or both of beams of the second set of beams and DL RSs of the second set of DL RS; a minimum number of one or both of beams of the second set of beams and DL RSs of the second set of DL RS; a machine learning, ML, model processing capability associated with the artificial intelligence model; and prediction performance for one or more combinations of the first set of DL RSs and the second set of DL RSs.

In some embodiments, the network node is further configured to transmit, to the network node, a third message including uplink (UL) assistance information. The UL assistance information includes one or more of WD location information, an estimate of one or both of WD velocity and WD rotation, information about WD antenna panels, and information about WD antenna panels configuration usage.

In some other embodiments, the DL RS configuration includes two CSI-RS resource sets. The two CSI-RS resource sets include a first CSI-RS resource set having M CSI-RS resources associated with the first set of beams and a second CSI-RS resource set having N CSI-RS resources associated with the second set of beams.

In some embodiments, one or more of the second CSI-RS resource set is a subset of the first CSI-RS resource set; the first CSI-RS resource set and the second CSI-RS resource set are linked via a link, where the link indicates that a same beam from the network node is to be used for a CSI-RS resource when the CSI-RS resource is transmitted as part of the first CSI-RS resource set as when the CSI-RS resource is transmitted as part of the second CSI-RS resource set; the link is explicitly configured per CSI-RS resource set; and the link is configured by field in the CSI report configuration.

In some other embodiments, one or more of: (A) the CSI report configuration includes two report settings, where each report setting points at one CSI-RS resource set each, a parameter configured per report setting, and when the two report settings are configured with the same parameter, the two CSI-RS resource sets associated with the two report settings are assumed to be linked together; (B) the link is explicitly configured in one resource setting; (C) an explicit indication links the two CSI-RS resource sets together; (D) the CSI-RS resource in the first CSI-RS resource set and the CSI-RS resource in the second CSI-RS resource set is one of the same CSI-RS resource and a different CSI-RS resource; (E) the link of two CSI-RS resources is explicitly configured per CSI-RS resource; (F) the link of two CSI-RS resources is explicitly configured explicitly configured in a table; (G) the link of two CSI-RS resources is dynamically indicated; and (H) the first and second CSI-RS resource set have one of the same time domain behavior and different time domain behavior.

In some embodiments, the DL RS configuration includes a first single CSI-RS resource set having M CSI-RS resources associated with the first set of beams or a second single CSI-RS resource set having N CSI-RS resources associated with the second set of beams, and one or both of: (A) the CSI report configuration indicates CSI-RS resources in the CSI-RS resource set the WD is to measure; and (B) DL RS configuration indicates which CSI-RS resources in the CSI-RS resource set the WD is to measure.

In some other embodiments, the network node is further configured to transmit beam assistance information indicating a spatial correlation and a quasi co-collocation (QCL) relation between one or more of beams of the first set of beams, the beam assistance information being usable as an input to the artificial intelligence model.

In some embodiments, the network node is further configured to receive, from the WD, information about predicted one or more sets of beams.

In some other embodiments, the one or more network node actions include transmitting signaling using one or more beams corresponding to the information about the predicted one or more sets of beams.

According to another aspect, a method in a network node is described. The network node is configured to communicate with a wireless device (WD) configured to predict at least reference signals (RSs) associated with the network node. The method includes transmitting a downlink (DL) RS configuration for configuring two or more sets of reference signal resources. The DL RS configuration includes a first configuration for a first set of beams and a second configuration for a second set of beams. The second set of beams is a subset of the first set of beams. The method further includes transmitting a CSI report configuration associated with the DL reference signal configuration and transmit a first message requesting the WD to measure, according to the CSI report configuration, on a subset of DL RSs of a first set of DL RSs associated with the first set of beams. The method further includes receiving, from the WD, information about the one or more RSs that are predicted from the first set of DL RSs associated with the first set of beams based in part on one or more WD actions. The one or more WD actions are associated with an artificial intelligence model and are performed using at least measurements on the subset of DL RSs of the second set of DL RSs. One or more network node actions are performed based on the information about the one or more RSs that are predicted from the first set of DL RSS.

In some embodiments, the method further includes transmitting a second message requesting the WD to measure the first set of DL RSs, where the first set of DL RSs are transmitted less often than the second set of DL RSs.

In some other embodiments, the method further includes receiving, from the WD, a capability indication. The capability indication indicates one or more of prediction support; support for a spatial predicted beam report for predicting one or both of beams from the first set of beams and reference signals from the first set of RSs; a first maximum number of one or both of beams of the first set of beams and DL RSs of the first set of DL RS; a second maximum number of one or both of beams of the second set of beams and DL RSs of the second set of DL RS; a minimum number of one or both of beams of the second set of beams and DL RSs of the second set of DL RS; a machine learning, ML, model processing capability associated with the artificial intelligence model; and prediction performance for one or more combinations of the first set of DL RSs and the second set of DL RSs.

In some embodiments, the method further includes transmitting, to the network node, a third message including uplink (UL) assistance information. The UL assistance information includes one or more of WD location information, an estimate of one or both of WD velocity and WD rotation, information about WD antenna panels, and information about WD antenna panels configuration usage.

In some other embodiments, the DL RS configuration includes two CSI-RS resource sets. The two CSI-RS resource sets include a first CSI-RS resource set having M CSI-RS resources associated with the first set of beams and a second CSI-RS resource set having N CSI-RS resources associated with the second set of beams.

In some embodiments, one or more of the second CSI-RS resource set is a subset of the first CSI-RS resource set; the first CSI-RS resource set and the second CSI-RS resource set are linked via a link, where the link indicates that a same beam from the network node is to be used for a CSI-RS resource when the CSI-RS resource is transmitted as part of the first CSI-RS resource set as when the CSI-RS resource is transmitted as part of the second CSI-RS resource set; the link is explicitly configured per CSI-RS resource set; and the link is configured by field in the CSI report configuration.

In some other embodiments, one or more of: (A) the CSI report configuration includes two report settings, where each report setting points at one CSI-RS resource set each, a parameter configured per report setting, and when the two report settings are configured with the same parameter, the two CSI-RS resource sets associated with the two report settings are assumed to be linked together; (B) the link is explicitly configured in one resource setting; (C) an explicit indication links the two CSI-RS resource sets together; (D) the CSI-RS resource in the first CSI-RS resource set and the CSI-RS resource in the second CSI-RS resource set is one of the same CSI-RS resource and a different CSI-RS resource; (E) the link of two CSI-RS resources is explicitly configured per CSI-RS resource; (F) the link of two CSI-RS resources is explicitly configured explicitly configured in a table; (G) the link of two CSI-RS resources is dynamically indicated; and (H) the first and second CSI-RS resource set have one of the same time domain behavior and different time domain behavior.

In some embodiments, the DL RS configuration includes a first single CSI-RS resource set having M CSI-RS resources associated with the first set of beams or a second single CSI-RS resource set having N CSI-RS resources associated with the second set of beams, and one or both of: (A) the CSI report configuration indicates CSI-RS resources in the CSI-RS resource set the WD is to measure; and (B) DL RS configuration indicates which CSI-RS resources in the CSI-RS resource set the WD is to measure.

In some other embodiments, the method further includes transmitting beam assistance information indicating a spatial correlation and a quasi co-collocation (QCL) relation between one or more of beams of the first set of beams, the beam assistance information being usable as an input to the artificial intelligence model.

In some embodiments, the method further includes receiving, from the WD, information about predicted one or more sets of beams.

In some other embodiments, the one or more network node actions include transmitting signaling using one or more beams corresponding to the information about the predicted one or more sets of beams.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of a beam management procedure;

FIG. 2: is a schematic diagram depicting two devices moving/turning around a corner;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of an example process in a wireless device according to some embodiments of the present disclosure;

FIG. 11 is a flowchart of an example process in a network node according to some embodiments of the present disclosure;

FIG. 12 is a flowchart of an example process in a wireless device according to some embodiments of the present disclosure;

FIG. 13 is a diagram of an example configuration of sets of resources according to some embodiments of the present disclosure;

FIG. 14 is a diagram of another example configuration of sets of resources according to some embodiments of the present disclosure;

FIG. 15 is a diagram of example configuration of first and second sets of beams, where the second set is a subset of the first set, according to some embodiments of the present disclosure;

FIG. 16 is a diagram of an example of measurements performed on a first set of beams and a subset thereof, according to some embodiments of the present disclosure;

FIG. 17 is a diagram of an example of the AI/ML model using the RSRP measurements, according to some embodiments of the present disclosure; and

FIG. 18 is a flowchart of an example process in accordance with the present disclosure.

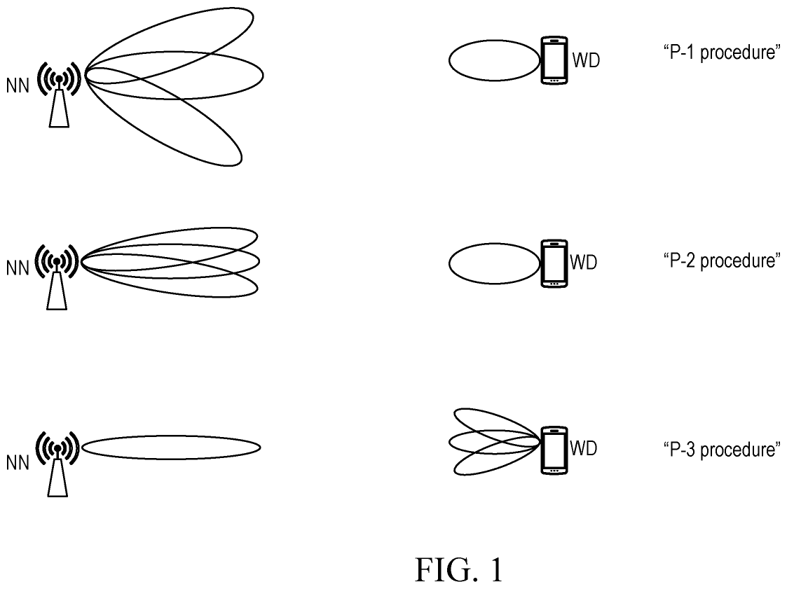

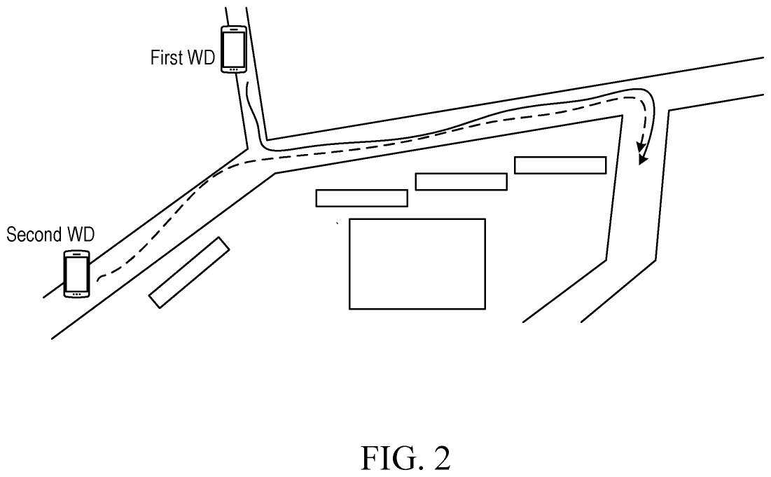

### DETAILED DESCRIPTION

Before describing in detail example embodiments, it is noted that the embodiments reside primarily in combinations of apparatus components and processing steps related to prediction of a preferred beam among F beams. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide prediction of a preferred beam among F beams. Some advantages of various embodiments according to the present disclosure include enabling spatial beam prediction at wireless device side for 5G advance and/or 6G using AI/ML based approaches, which can be used to reduce DL-RS overhead during beam management procedures as well as measurement complexity reduction of the wireless device. Another advantage may be that the network vendor avoids disclosing proprietary implementation details of antennas or used beams such as beam radiation patterns.

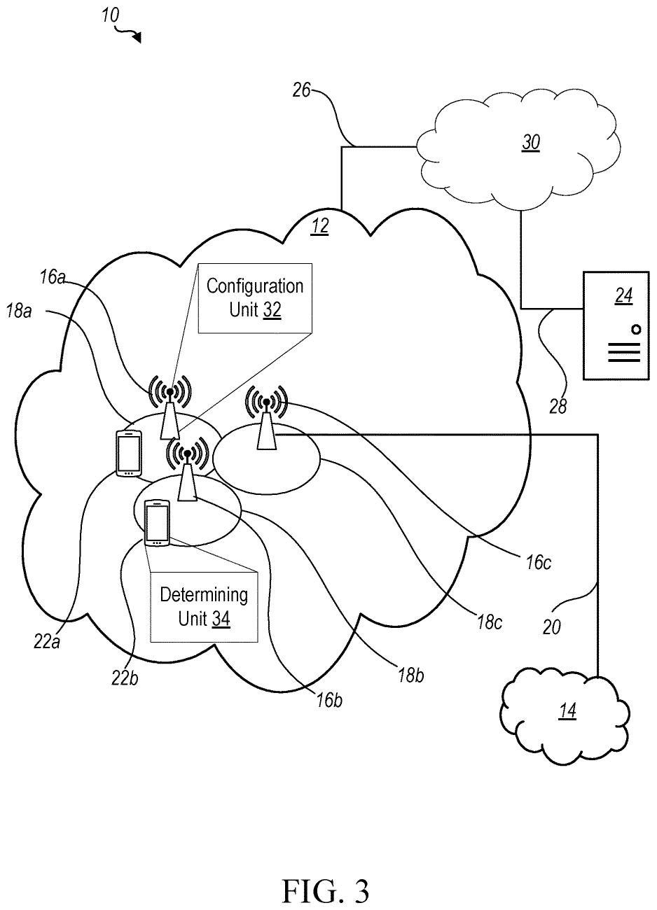

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein, including functions related to prediction of a preferred beam among a set of F beams. A wireless device 22 is configured to include a determining unit 34 which is configured to perform one or more network node 16 functions described herein, including functions related to prediction of a preferred beam among a set of F beams.

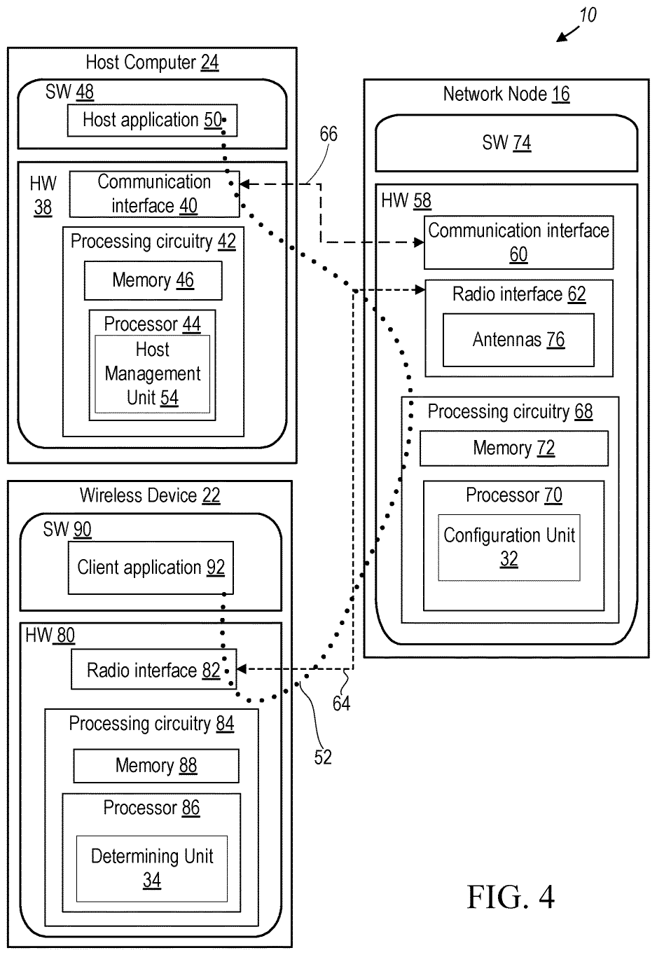

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a control unit 54 configured to enable the service provider to observe, monitor, control, transmit to, and receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions described herein, including functions related to prediction of a preferred beam among a set of F beams.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a determining unit 34 configured to perform one or more network node 16 functions described herein, including functions related to prediction of a preferred beam among a set of F beams.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as configuration unit 32 and determining unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

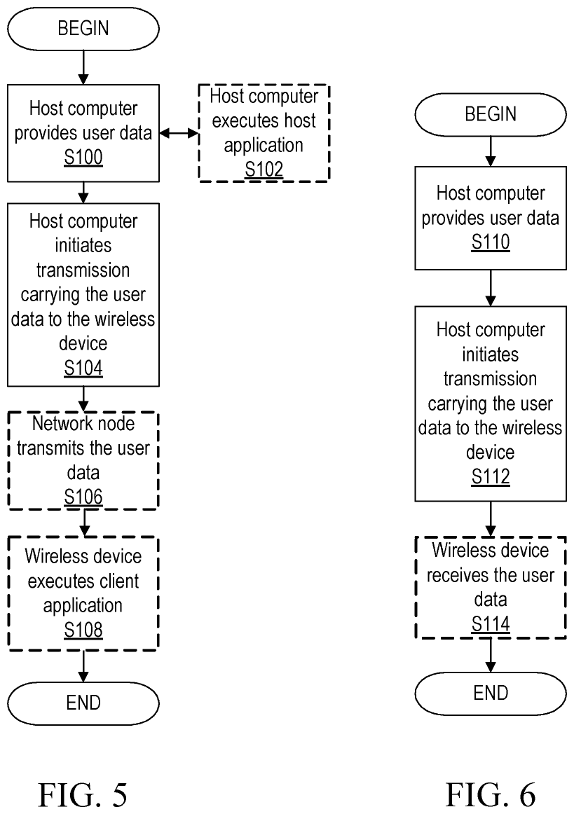

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

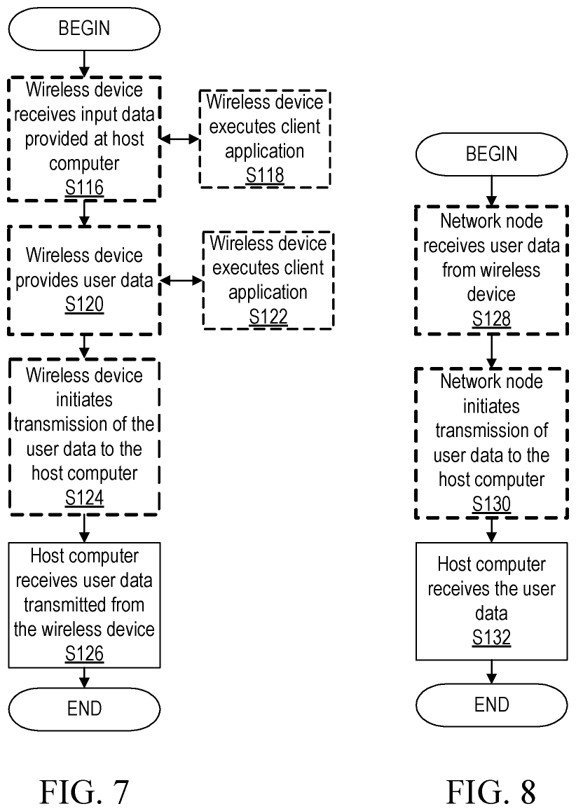

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

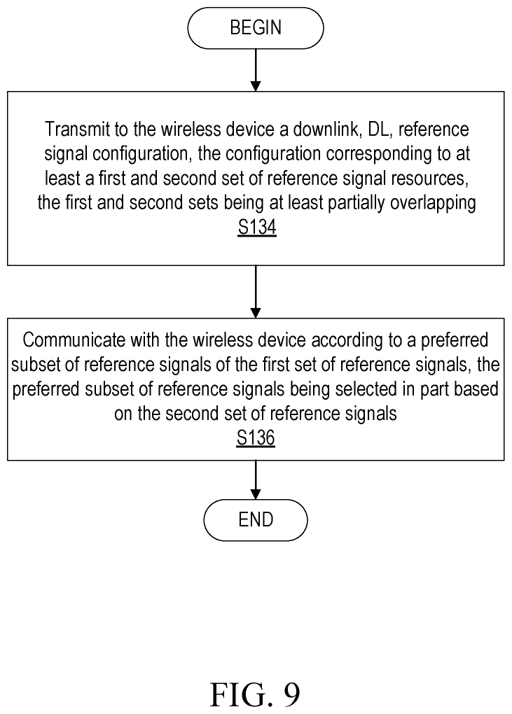

FIG. 9 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. The network node 16 is configured to transmit to the wireless device a downlink, DL, reference signal configuration, the configuration corresponding to at least a first and second set of reference signal resources where the first and second sets at least partially overlap (Block S134). The network node 16 is also configured to communicate with the wireless device according to a preferred subset of reference signals of the first set of reference signals where the preferred subset of reference signals are selected in part based on the second set of reference signals (Block S136).

In at least one embodiment, the reference signal configuration includes at least one of quasi co-located type D relationship and a spatial transmitter filter. In at least one embodiment, the method further includes transmitting a trigger on the preferred subset of reference signals to cause the wireless device 22 to perform at least one measurement relating to the second set of reference signals.

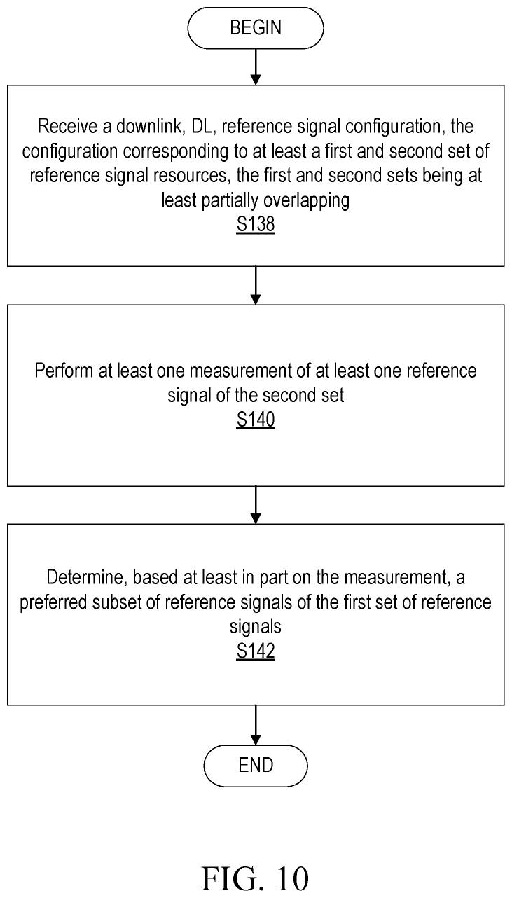

FIG. 10 is a flowchart of an example process in a wireless device 22 according to some embodiments of the present disclosure. One or more blocks described herein may be performed by one or more elements of wireless device 22 such as by one or more of processing circuitry 84 (including the determining unit 34), processor 86, radio interface 82 and/or communication interface 60. The wireless device 22 is configured to receive a downlink, DL, reference signal configuration where the configuration corresponds to at least a first and second set of reference signal resources, and the first and second sets at least partially overlap (Block S138). The wireless device 22 is also configured to perform at least one measurement of at least one reference signal of the second set (Block S140). The wireless device 22 is also configured to determine, based at least in part on the measurement, a preferred subset of reference signals of the first set of reference signals (Block S142).

In at least one embodiment the reference signal configuration includes at least one of quasi co-located type D relationship and a spatial transmitter filter. In at least one embodiment, the performing of the at least one measurement relating to the second set of reference signals is in response to receiving a trigger.

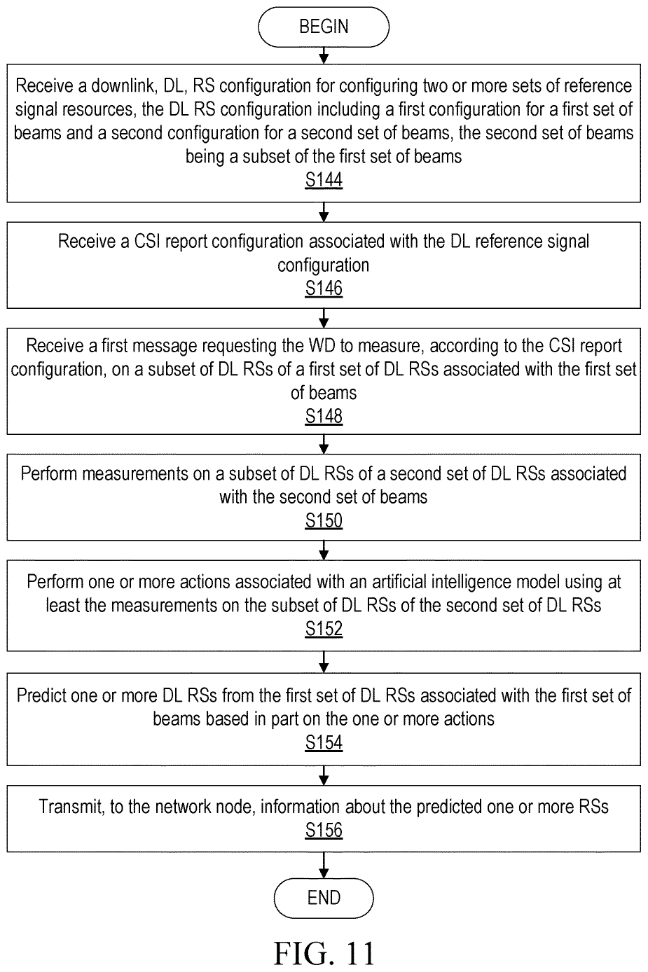

FIG. 11 is a flowchart of an example process in a wireless device 22 according to some embodiments of the present disclosure. One or more blocks described herein may be performed by one or more elements of wireless device 22 such as by one or more of processing circuitry 84 (including the determining unit 34), processor 86, radio interface 82 and/or communication interface 60. The wireless device 22 is configured to receive (Block S144) a downlink (DL) RS configuration for configuring two or more sets of reference signal resources. The DL RS configuration includes a first configuration for a first set of beams and a second configuration for a second set of beams. The second set of beams is a subset of the first set of beams. The wireless device 22 is further configured to receive (Block S146) a CSI report configuration associated with the DL reference signal configuration, receive (Block S148) a first message requesting the WD 22 to measure, according to the CSI report configuration, on a subset of DL RSs of a first set of DL RSs associated with the first set of beams, and perform (Block S150) measurements on a subset of DL RSs of a second set of DL RSs associated with the second set of beams. The wireless device 22 is also configured to perform (Block S152) one or more actions associated with an artificial intelligence model using at least the measurements on the subset of DL RSs of the second set of DL RSs, predict (Block S154) one or more DL RSs from the first set of DL RSs associated with the first set of beams based in part on the one or more actions, and transmit (Block S156), to the network node 16, information about the predicted one or more RSs.

In some embodiments, the method further includes receiving a second message requesting the WD 22 to measure the first set of DL RSs. The first set of DL RSs is transmitted less often than the second set of DL RSs.

In some other embodiments, the method further includes performing collection of data associated with performance of the prediction of the one or more DL RSs from the first set of DL RSs based on measurements on the second set of DL RSs.

In some embodiments, the method further includes transmitting, to the network node 16, a capability indication indicating one or more of: prediction support; support for a spatial predicted beam report for predicting one or both of beams from the first set of beams and reference signals from the first set of RSs; a first maximum number of one or both of beams of the first set of beams and DL RSs of the first set of DL RS; a second maximum number of one or both of beams of the second set of beams and DL RSs of the second set of DL RS; a minimum number of one or both of beams of the second set of beams and DL RSs of the second set of DL RS; a machine learning, ML, model processing capability associated with the artificial intelligence model; and prediction performance for one or more combinations of the first set of DL RSs and the second set of DL RSs.

In some other embodiments, the method further includes transmitting, to the network node 16, a third message including uplink (UL) assistance information. The UL assistance information includes one or more of WD location information, an estimate of one or both of WD velocity and WD rotation, information about WD antenna panels, and information about WD antenna panels configuration usage.

In some embodiments, the DL RS configuration includes two CSI-RS resource sets, the two CSI-RS resource sets including a first CSI-RS resource set having M CSI-RS resources associated with the first set of beams and a second CSI-RS resource set having N CSI-RS resources associated with the second set of beams.

In some other embodiments, one or more of the second CSI-RS resource set is a subset of the first CSI-RS resource set; the first CSI-RS resource set and the second CSI-RS resource set are linked via a link, where the link indicates that a same beam from the network node 16 is to be used for a CSI-RS resource when the CSI-RS resource is transmitted as part of the first CSI-RS resource set as when the CSI-RS resource is transmitted as part of the second CSI-RS resource set; the link is explicitly configured per CSI-RS resource set; and the link is configured by field in the CSI report configuration.

In some embodiments, one or more of the CSI report configuration includes two report settings, where each report setting points at one CSI-RS resource set each, a parameter is configured per report setting, and when the two report settings are configured with the same parameter, the two CSI-RS resource sets associated with the two report settings are assumed to be linked together; the link is explicitly configured in one resource setting; an explicit indication links the two CSI-RS resource sets together; the CSI-RS resource in the first CSI-RS resource set and the CSI-RS resource in the second CSI-RS resource set is one of the same CSI-RS resource and a different CSI-RS resource; the link of two CSI-RS resources is explicitly configured per CSI-RS resource; the link of two CSI-RS resources is explicitly configured explicitly configured in a table; the link of two CSI-RS resources is dynamically indicated; and the first and second CSI-RS resource set have one of the same time domain behavior and different time domain behavior.

In some other embodiments, the DL RS configuration includes a first single CSI-RS resource set having M CSI-RS resources associated with the first set of beams or a second single CSI-RS resource set having N CSI-RS resources associated with the second set of beams, and one or both of: (A) the CSI report configuration indicates CSI-RS resources in the CSI-RS resource set the WD 22 is to measure; and (B) DL RS configuration indicates which CSI-RS resources in the CSI-RS resource set the WD 22 is to measure.

In some embodiments, the method further includes receiving beam assistance information indicating a spatial correlation and a quasi co-collocation (QCL) relation between one or more of beams of the first set of beams, where the beam assistance information is usable as an input to the artificial intelligence model.

In some other embodiments, the method further includes predicting one or more set of beams from the first set of beams based in part on the one or more actions and transmitting, to the network node 16, information about the predicted one or more sets of beams.

In some embodiments, the one or more actions include one or more of training the artificial model, retraining the artificial model, and updating the artificial model.

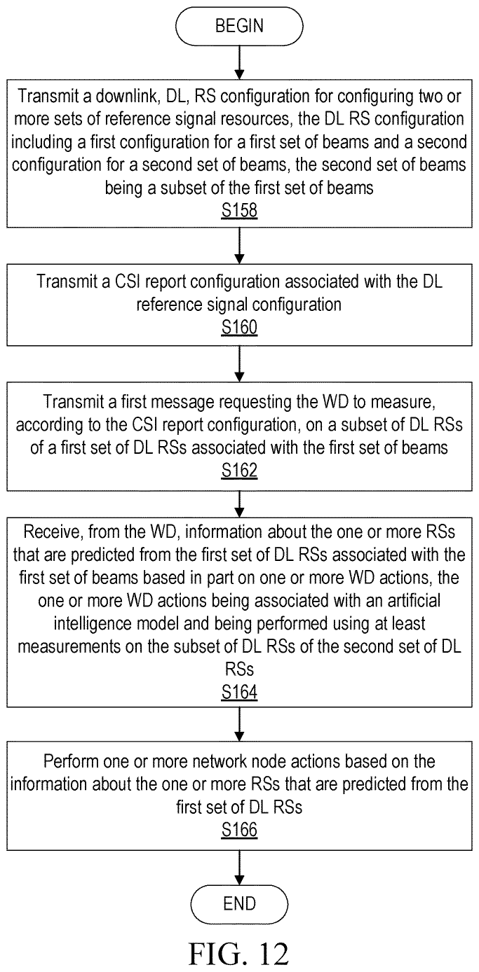

FIG. 12 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. The network node 16 is configured to transmit (Block S158) a downlink (DL) RS configuration for configuring two or more sets of reference signal resources. The DL RS configuration includes a first configuration for a first set of beams and a second configuration for a second set of beams. The second set of beams is a subset of the first set of beams. The network node 16 is further configured to transmit (Block S160) a CSI report configuration associated with the DL reference signal configuration and transmit (Block S162) a first message requesting the WD 22 to measure, according to the CSI report configuration, on a subset of DL RSs of a first set of DL RSs associated with the first set of beams. The network node 16 is also configured to receive (Block S164), from the WD 22, information about the one or more RSs that are predicted from the first set of DL RSs associated with the first set of beams based in part on one or more WD actions. The one or more WD actions are associated with an artificial intelligence model and being performed using at least measurements on the subset of DL RSs of the second set of DL RSs. Further, The network node 16 is configured to perform (Block S166) one or more network node actions based on the information about the one or more RSs that are predicted from the first set of DL RSs.

In some embodiments, the method further includes transmitting a second message requesting the WD 22 to measure the first set of DL RSs, where the first set of DL RSs are transmitted less often than the second set of DL RSs.

In some other embodiments, the method further includes receiving, from the WD 22, a capability indication. The capability indication indicates one or more of prediction support; support for a spatial predicted beam report for predicting one or both of beams from the first set of beams and reference signals from the first set of RSs; a first maximum number of one or both of beams of the first set of beams and DL RSs of the first set of DL RS; a second maximum number of one or both of beams of the second set of beams and

DL RSs of the second set of DL RS; a minimum number of one or both of beams of the second set of beams and DL RSs of the second set of DL RS; a machine learning, ML, model processing capability associated with the artificial intelligence model; and prediction performance for one or more combinations of the first set of DL RSs and the second set of DL RSs.

In some embodiments, the method further includes transmitting, to the network node 16, a third message including uplink (UL) assistance information. The UL assistance information includes one or more of WD location information, an estimate of one or both of WD velocity and WD rotation, information about WD antenna panels, and information about WD antenna panels configuration usage.

In some other embodiments, the DL RS configuration includes two CSI-RS resource sets. The two CSI-RS resource sets include a first CSI-RS resource set having M CSI-RS resources associated with the first set of beams and a second CSI-RS resource set having N CSI-RS resources associated with the second set of beams.

In some embodiments, one or more of the second CSI-RS resource set is a subset of the first CSI-RS resource set; the first CSI-RS resource set and the second CSI-RS resource set are linked via a link, where the link indicates that a same beam from the network node 16 is to be used for a CSI-RS resource when the CSI-RS resource is transmitted as part of the first CSI-RS resource set as when the CSI-RS resource is transmitted as part of the second CSI-RS resource set; the link is explicitly configured per CSI-RS resource set; and the link is configured by field in the CSI report configuration.

In some other embodiments, one or more of: (A) the CSI report configuration includes two report settings, where each report setting points at one CSI-RS resource set each, a parameter configured per report setting, and when the two report settings are configured with the same parameter, the two CSI-RS resource sets associated with the two report settings are assumed to be linked together; (B) the link is explicitly configured in one resource setting; (C) an explicit indication links the two CSI-RS resource sets together; (D) the CSI-RS resource in the first CSI-RS resource set and the CSI-RS resource in the second CSI-RS resource set is one of the same CSI-RS resource and a different CSI-RS resource; (E) the link of two CSI-RS resources is explicitly configured per CSI-RS resource; (F) the link of two CSI-RS resources is explicitly configured explicitly configured in a table; (G) the link of two CSI-RS resources is dynamically indicated; and (H) the first and second CSI-RS resource set have one of the same time domain behavior and different time domain behavior.

In some embodiments, the DL RS configuration includes a first single CSI-RS resource set having M CSI-RS resources associated with the first set of beams or a second single CSI-RS resource set having N CSI-RS resources associated with the second set of beams, and one or both of: (A) the CSI report configuration indicates CSI-RS resources in the CSI-RS resource set the WD 22 is to measure; and (B) DL RS configuration indicates which CSI-RS resources in the CSI-RS resource set the WD 22 is to measure.

In some other embodiments, the method further includes transmitting beam assistance information indicating a spatial correlation and a quasi co-collocation (QCL) relation between one or more of beams of the first set of beams, the beam assistance information being usable as an input to the artificial intelligence model.

In some embodiments, the method further includes receiving, from the WD 22, information about predicted one or more sets of beams.

In some other embodiments, the one or more network node actions include transmitting signaling using one or more beams corresponding to the information about the predicted one or more sets of beams.

Having described the general process flow of arrangements of the disclosure and having provided examples of hardware and software arrangements for implementing the processes and functions of the disclosure, the sections below provide details and examples of arrangements for prediction of a preferred beam among a set of fixed beams (“F beams”).

Some embodiments provide for a wireless device configured to at least once measure on all available F beams (Set A) and that these F beams defines the “prediction set” of beams, i.e., the predictor that is based on Set B measurements has an output that maps to one or more of the F beams in Set A. One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc.

### General Overview of One or More Embodiments

The present disclosure describes one or more embodiments on how to perform model training and model inference for AI/ML based spatial beam prediction at the wireless device 22 side and how to introduce such methods in 3GPP CSI framework specification.

More specifically, the prevent disclosure details how the Set A and Set B of DL RS, where each DL RS is transmitted by the network node 16 using a certain (fixed by implementation design/cell planning for the given cell) MIMO precoding vector and thus these DL RS are defining so called “beams.”

The DL RS (and their relationship to one another, e.g., QCL) can be configured in a way that enables wireless device's 22 to use AI/ML models to reliably predict the “best beam”/DL RS without needing to measure all possible (denoted as the number F) beams/DL RS (thus saving beam-management overhead), and how the wireless device 22 train(s) or re-trains (updates) the AI/ML model (e.g., inference function) which predicts the Set A based on measurements of Set B, based on the one or more measurements on the configured Set B (online training) and CSI measurements on the Set A. One or more embodiments includes the possibility for the network node 16 to also transmit resources associated to the Set A, in one or more measurements occasions, so these are used as input to the AI/ML model for data collection and training purposes.

In at least one embodiment, the wireless device 22 is configured with a first set of DL RS resources associated to the Set B and DL RS resources associated to the Set A, wherein the wireless device 22 performs one or more spatial domain predictions for Set A (based on CSI measurements on a Set B), wherein the spatial domain predictions are performed by a function (AI/ML inference function, AI/ML model). The wireless device 22 performs data collection for training that AI/ML model based on the Set B of resources, transmitted by the network node 16, and the transmission occasions of the Set A (which may be transmitted less often than the Set B and/or on demand, in the case the Set A for data collection is configured as an aperiodic resource).

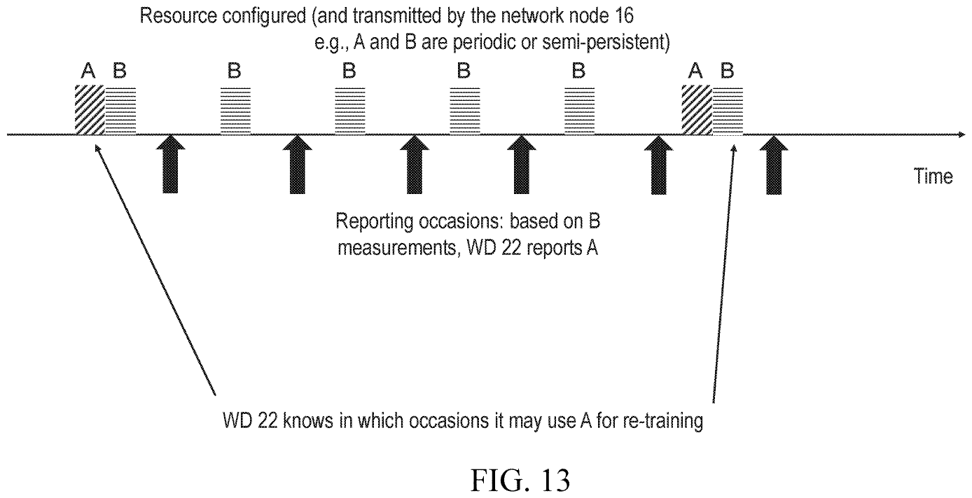

A first example is shown in FIG. 13 for the case of Set B configured as a periodic set of resources, used for both CSI measurements to be used as input for the Set A spatial-domain predictions and for the data collection for the training of the AI/ML model; and, the Set A is also configured as a periodic set of resources, with longer periodicity than the set B (wherein the transmission of Set A are primarily used for data collection for training the AI/ML model). In one option, the wireless device 22 actually reports the CSI measurements on A instead of predictions if the Set A is available.

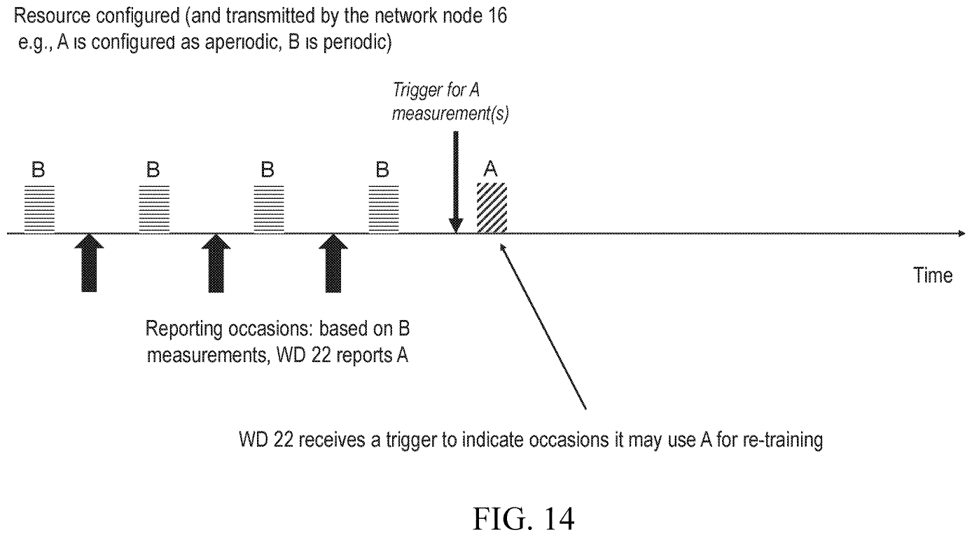

A second example is shown in FIG. 14 for the case of Set B configured as a periodic set of resources, used for both CSI measurements to be used as input for the Set A spatial-domain predictions and for the data collection for the training of the AI/ML model; and, the Set A is also configured as an aperiodic or semi-persistent set of resources (with longer periodicity than the set B in case of semi-persistent, wherein the transmission of Set A are primarily used for data collection for training the AI/ML model). In one option, the wireless device 22 actually report the CSI measurements on A instead of predictions if the Set A is available.

In at least one embodiment, the wireless device 22 transmits a request to the network node 16 for activating the configuration of the Set A transmissions, so the wireless device 22 performs the data collection for training the AI/ML model. In other words, in response to the request the wireless device 22 receives a command (e.g., DCI and/or medium access control (MAC) control element (CE)) activating the Set A resources, so the wireless device 22 may perform the CSI measurements on the Set A for data collection.

When the Set A starts to get transmitted the wireless device 22 may perform CSI measurements on A, which is the Set for which the network wants CSI reports, the wireless device 22 may perform CSI measurements on A for reporting purposes instead of using the Set B to predict the set A. Thus, the network node 16 may stop transmitting the set B while it is transmitting the Set A.

In at least one embodiment, the wireless device 22 indicates to the network that data collection is over e.g., when the wireless device 22 finishes the AI/ML model training.
In at least one embodiment, the wireless device 22 receives from the network node 16 an indication that the network node 16 has stopped transmitting the sets of DL RSs and an indication to deactivate (e.g., MAC CE and/or DCI) and/or to remove the DL RS resource sets at the wireless device (e.g., an RRC Reconfiguration message).

In at least one embodiment, when the wireless device is configured for data collection according to the method the wireless device starts a timer (Txxx) and while the timer is running the wireless device performs data collection for training, and expects the network to transmit the DL RSs in sets A and B. When the timer expires, the wireless device stops data collection, e.g., stops performing measurements on the configured DL RSs in sets A and B. The network node 16 also keeps an instance of the timer and upon expiry it stops the transmissions of the DL RSs.

### Additional Details

As discussed above, spatial domain prediction of beams is one way to reduce the CSI measurements for beam management which a wireless device 22 may be required to performed, e.g., based on an AI/ML function at the wireless device 22, one spatial AI/ML beam prediction method is to select one or more beam from a Set A of beams (which network may use to serve the wireless device 22, and associated to one or more TCI states the wireless device 22 is configured with) based on measurements on a Set B of beams (e.g., wherein measurements are on DL RSs transmitted in these beams of Set V), where the Set B of beams are different than the Set A of beams (for example, the Set B of beams are wide beams, and the Set A of beams are narrow beams).

3GPP may need to agree on a way to configure wireless devices 22 with the Set A and Set B of beams in a way that enables AI/ML model training and inference to reduce beam-management overhead.

In the present disclosure, a spatial domain beam prediction (SDBP) AI/ML model can be viewed as a functionality or part of a functionality that is related to spatial domain beam prediction and is deployed/implemented/configured/defined in a wireless device 22. Further although one focus is on spatial beam prediction it should be noted that the wireless device 22 may support joint spatial and temporal domain prediction and hence spatial domain beam prediction can further also include temporal domain prediction.

A SDBP AI/ML model can be defined as a feature, or part of a feature, that is implemented/supported in a wireless device 22, and the wireless device 22 can indicate the feature version to another node (e.g., a network node 16). If the AI/ML model is updated, the feature version may be changed by the wireless device 22. The AI/ML model may be any trainable ML algorithm including but not limited to, for example, artificial neural networks, decision trees, random forests, nearest neighbors, and support vector machines.

An SDBP AI/ML-model may correspond to a function that receives one or more inputs (e.g., channel measurements on a set B of beams) and outputs one-or-more decisions, estimates, or prediction(s) of a certain type (e.g., CSI for a set A of beams, or top-K predicted beams from set A of beams).

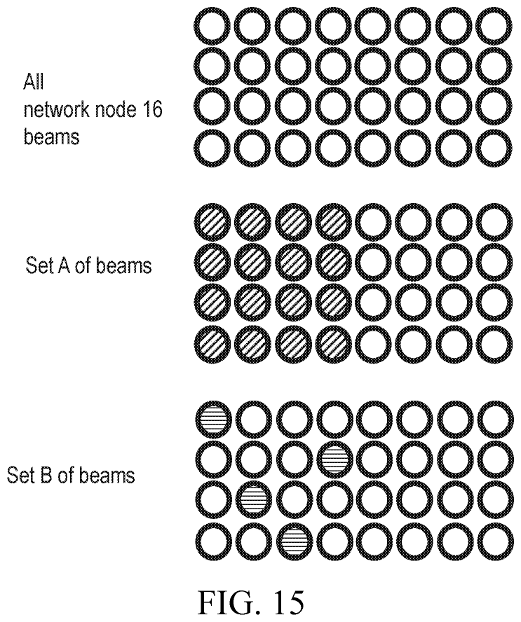

FIG. 15 illustrates schematic example of Set A and Set B of beams, where Set B of beams are a subset of the Set A of beams.
The top portion of FIG. 15 depicts all feasible (e.g., possible) candidate network node 16 beams.
The middle portion of FIG. 15 depicts one example for the Set A of beams (the Set A of beams can be all or a subset of all of the network node 16 beams), hence F=16 here. For example,
   The Set A of beams might be all F=16 beams with an azimuth angle in the range [0,90] degrees, as show in FIG. 15 (e.g., the wireless device 22 is positioned in the left-half of the sector).
   The Set A of beams might be all beams with a zenith angle pointing towards the horizon (e.g., if the distance from the wireless device 22 to the network node 16 is large).
   The Set A can in one embodiment be selected by the network using measurements and reports from the wireless device 22 on SSB
The lower portion of FIG. 13 depicts the Set B of beams (which is a subset of the Set A of beams).
   Hence, the NW/network node 16 may only need to transmit 4 DL RS and the wireless device 22 may only need to measure 4 DL RS, instead of all F=16.

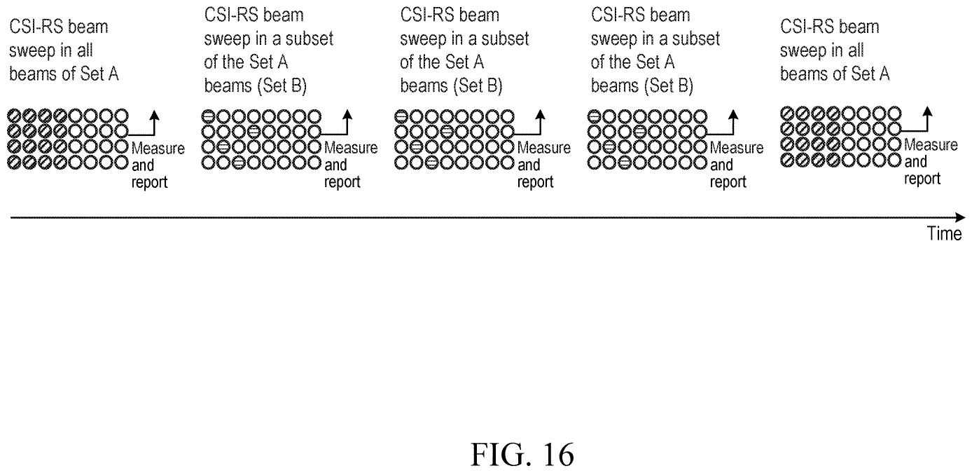

Another aspect of the present disclosure is illustrated in FIG. 16. For inference i.e., beam prediction purpose, the wireless device 22 is configured by the network/network node 16 with Set A of reference signals. Within Set A some of the reference signals (Set B) are transmitted so they can be measured by the wireless device 22 and some are not transmitted.

The wireless device 22 may, after being triggered by the network node 16 to measure on the subset of Set B reference signals that are transmitted and based on the measurement, aim to perform a prediction of the best or k best reference signal within the set A of reference signals.

Hence, the inference may use both a measurement of Set A and Set B, while the output from the inference is in the space of Set A reference signal indices (i.e., beam indices).

The wireless device 22 may further report the result of the prediction to the network node 16, i.e., the best or k best predicted reference signals in Set A within a certain metric. The reference signals can be reported as an ID form them to lower the overhead and the metric can for example be one of the following ones, RSRP, RSRQ, RSSI, SINR, rank, CQI and any other radio related measurement.

Some of the reference signals in set A and set B are transmitted within the same beam which may be indicated to the wireless device 22 by some form of identification. This could for example be indicated by that they share the same spatial correlation or the same TCI state or be related with QCL Type D. Or simply that they have the same DL RS identifier.

The set B of reference signals is typically transmitted less often than the set A of reference signals. The wireless device 22 can utilize the set A reference signals for data collection or monitoring the prediction accuracy of its prediction model. The prediction of the model can be compared by the wireless device 22 by running is prediction model and compare that to actual measurements within Set A. If the model performs under a certain threshold, the wireless device 22 can indicate that to the network node 16 that the predictions are no longer supported or indicate that the predictions may not be accurate.

An example method is provided as follows:
First step: The network node 16 transmits a CSI-RS beam sweep using all the F narrow beams of Set A. Hence, F CSI-RS resources is used, typically each resource have one or two antenna ports.
Second step: The network node 16 transmits subsequent CSI-RS beam sweeps in a subset of the beams used in the first step (i.e., using Set B of beams which is a subset of the Set A beams). This transmission can be either wireless device 22 specific (configured for an individual wireless device 22), or cell specific (the same configuration used by all wireless devices 22 in the cell).
Third step: The wireless device 22 predicts a preferred beam from the Set A of beams, using at least measurements on the Set B of beams. The SDBP AI/ML model may take additional inputs/features, such as an estimate of the wireless device's 22 position or a line-of-sight/non-line-of-sight classification probability or wireless device 22 antenna panel identifier. The SDBP AI/ML model may also explicitly or implicitly take input the association between a DL RS in Set A and a DL RS in Set B, e.g., if they are transmitted with the same MIMO precoder/DL spatial filter/QCL Type-D relation. This information is important for the AI/ML model to “know” that it is measuring an actual beam in output the Set A.
   Since the Set B of beams are fewer than the Set A of beams, the associated CSI-RS overhead is reduced compared to transmitting CSI-RS resource in all Set A of beams each beam sweep (with a limited drop in performance if the AI/ML model predicts the beams in efficient way). The Set A beams can be triggered infrequently to let the wireless device 22 collect training data and/or calibrate or finetune its SDBP AI/ML model. The triggering can in one embodiment be wireless device 22-based, where the wireless device 22 could trigger set A beams in case its performance drops (e.g., RSRP drops below a certain threshold). The triggering can in another be NW/network node 16 based, where the NW/network node 16 requires the wireless device 22 to test the model with a certain periodicity.

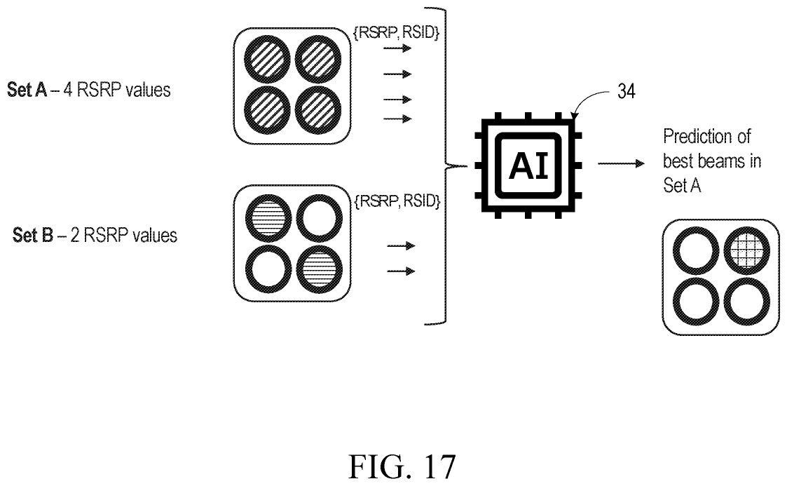

FIG. 17 illustrates a schematic example of the AI/ML model using the RSRP measurements from both Set A and Set B and the corresponding DL-RS IDs as input. In this example, the Set A beam sweep consist of 4 beams numbered (RSID) {1,2,3,4} which corresponds to 4 RSRP measurements. The Set B beam sweep may use a subset of set A, where only two of the four beams, numbered {1,4}, corresponds to two RSRP measurements. Due to fewer DL-RSs are transmitted in Set B compared to Set A, we attain both DL-RS resource overhead as well as measurement complexity reduction for the wireless device 22. Input to inference (beam prediction) of the AI/ML model is Set A and Set B RSRP measurements together with associated Set A indices from {1,2,3,4} and Set B indices {1,4}.

In one embodiment, the wireless device 22 performs the prediction based on several Set B beam sweeps, for example by averaging the RSRP measurements over the multiple sweeps etc.

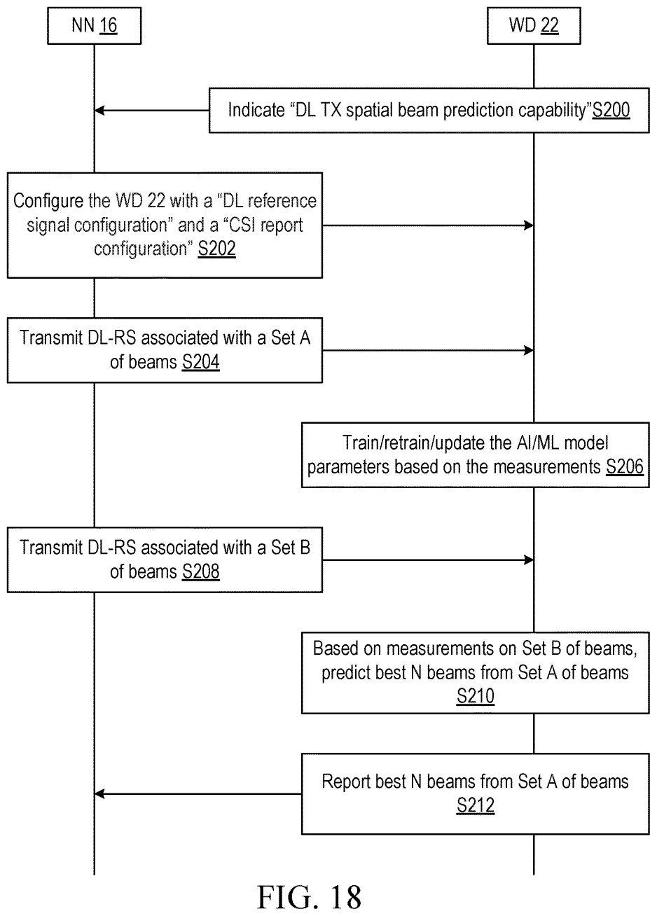

FIG. 18 illustrates a flowchart of an example method according to some embodiment of the present disclosure. In Block S200, the wireless device reports, for example during wireless device capability signaling, support for performing spatial beam prediction from a Set A of network node 16 beams based on measurements on a Set B of network node 16 beams. The wireless device capability signaling (“DL TX spatial beam prediction capability”) can for example consist of one or more of the following information:
Support of spatial predicted beam report from a Set A of beams based on measurements on a Set B of beams, where the Set B of beams are a subset of Set A of beams.
Maximum number of beams supported in Set A.
Maximum number of beams supported in Set B.
Minimum number of beams supported in Set B.
Prediction performance for each supported combination of Set A and B of beams. For example N1 beams in Set B and N2 beams in Set A implies a certain performance.
ML model processing capability (for instance, how much time does it take for the wireless device to retaining/update its model, which might impact the configuration of DL RS transmission, e.g., the periodicity of transmitting set A of beams, and the delta-time between transmitting set A of beams and transmitting set B of beams).

In Block S202, the network node 16 indicates the relevant configurations for the spatial beam prediction, for example a “DL reference signal configuration”, a “CSI report configuration” and a potential “network node TX beam assistance information”. The “DL reference signal configuration” can for example consist of one or more of.
Resource Setting (i.e., CSI-ResourceConfig as specified in, for example, 3GPP TS 38.311).
CSI-RS resource sets (i.e., NZP-CSI-RS-ResourceSet as specified in, for example, 3GPP TS 38.311).
CSI-RS resources (i.e., NZP-CSI-RS-Resource as specified in, for example, 3GPP TS 38.311)
New potential DL-RS resource configuration for 6G

The “CSI report configuration” can for example consist of one or more of.
Report Setting (i.e., CSI-ReportConfig as specified in, for example, 3GPP TS 38.311)
New potential CSI report configuration for 6G

The “network node TX beam assistance information” can for example consist of one or more of.
Spatial correlation between different network node 16 Tx beams
QCL association between different network node 16 TX beams.
Azimuth and elevation pointing angle of different network node 16 TX beams.
Beamwidth for different network node 16 TX beams

In Block S204, the network node 16 performs a first beam sweep by transmitting a first set of DL reference signals associated with the Set A of beams, and in Block S206, the wireless device 22 performs measurements on the Set A of beams and use these measurements as input to the AI/ML model (for example to train/retrain/update the AI/ML parameters).

In Block S208, the network node 16 transmits one sub-sequent beam sweep by transmitting a second set of DL reference signals associated with the Set B of beams, and in Block S210, the wireless device 22 performs measurements on the Set B of beams and use these measurements to predict the best N beams from the Set A of beams.

In Block S212, the wireless device 22 reports the N predicted beams from Set A.

Step Block S208 to Block S212 can then be repeated one or more times until the network node 16 starts over with Block S204 again.

In at least one embodiment, the linking of two different CSI-RS resource sets (associated with the Set A and Set B of beams) is explicitly indicated in an aperiodic trigger state (i.e., CSI-AperiodicTriggerState as specified in, for example, 3GPP TS 38.331). For example, the information element “CSI-AssociatedReportConfigInfo” included in an aperiodic trigger state (as specified in, for example, 3GPP TS 38.331) can be configured with an additional “reportConfigId” or an addition “resourcesForChannel”, which could indicate to the wireless device that the two CSI-RS resource sets (associated with either the two “reportConfigIds” or the two “resourcesForChannels”) are linked together. One example of how this could look like is illustrated by the bolded text in the below text, where an additional “reportConfigId” has been added. When the two CSI-RS resource sets are linked together, the wireless device may assume that a CSI-RS resource configured in both the CSI-RS resource sets should be transmitted in the same network node 16 TX beam, regardless of in which of the two linked CSI-RS resource sets that is transmitted.

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-
AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId

OPTIONAL -- Cond

Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |
| ResourceSetsPerConfig) | OPTIONAL, -- Cond CSI-IM-ForInterference |
| nzp-CSI-RS-ResourcesForInterference | INTEGER (1..maxNrofNZP-CSI-RS- |
| ResourceSetsPerConfig) | OPTIONAL, -- Cond NZP-CSI-RS-ForInterference |

...

| | |
|---|---|
| Additional_reportConfigId | CSI-ReportConfigId |

}
-- TAG-CSI-APERIODICTRIGGERSTATELIST-STOP
-- ASN1STOP

Various example methods in accordance with the present disclosure may be as follows:

1. A method in a wireless device 22 for selecting (and/or predicting) a preferred number k (k is equal or larger than 1) DL reference signals, the method including:
a. receiving a DL reference signal configuration, that configures two or more set of reference signal resources, (e.g., wherein at least one reference signal is configured to be part of more than one set, the sets are at least partly overlapping such as at least some reference signal resources of one set may be included in another set);
   i. including a configuration for a set A (the F beams to be candidates to be predicted and which are measured during training) and a configuration for Set B (beams to be measured during inference and/or training);
   ii. configuration may also contain QCL Type D relationship or a notion of same spatial Tx filter between the transmission of a DL reference signal in Set A and a DL reference signal in set B;
b. receiving a CSI report configuration associated with the DL reference signal configuration;
c. receiving a trigger message to measure according to the CSI Report configuration on a subset of the first set of reference signals (set A); and
d. performing measurements on a sub-set DL reference signals associated with a Set B;
e. reporting the identifier(s) of the preferred k reference signals within the Set A of reference signals based on the measured subset of the reference signals in set B.

2. The method of Example 1 above, wireless device 22 receives a trigger to (or a higher layer periodic configuration of) measure Set A reference signals, wherein the Set A reference signals may be received from the network node 16 less often than the Set B reference signals.

2b. The method of Example 1 above, wherein the configuration for a set A (DL RS associated to beams to be predicted and measured during training) is transmitted with a different (typically longer) periodicity than the set B (e.g., less often).

3. The method of Example 2 and/or 2a above, wherein the measurement from Set B reference signals is reported to the network node 16.

4. The method of Example 1 above, wherein the wireless device 22 the performs data collection or monitors the performance of the beam prediction based on set B measurements.

5. The method of Example 1 above, wherein the wireless device 22 sends a capability to the network node 16 indicating support for beam prediction, the capability can in addition indicate one or more of the following:
a. Support of spatial predicted beam report from a Set A of beams based on measurements on a Set B of beams, where the Set B of beams are a subset of Set A of beams.
b. Maximum number of beams/DL RS supported in Set A;
c. Maximum number of beams/DL RS supported in Set B;
d. Minimum number of beams/DL RS supported in Set B;
e ML model processing capability;
f. Prediction performance for various combination of set A and Set B.
g. The maximum supported ratio of number of configured DL RS in Set A divided by number of configured DL RS in Set B

6. The method of Example 1 above, wherein the wireless device 22 transmits a message (“UL assistance information”) to the network node 16 which includes one or more of:
a. A wireless device 22's location information, wherein the location may either be a physical location or a relative location towards the network nodes 16 antenna;
b. An estimate of the wireless device's 22 velocity and/or rotation. (in earth bounded coordinate system);
c. Information about the wireless 22 device antenna panels;
d. Information about the wireless 22 device antenna panels; configuration usage.

7. The method of Example 1 above, wherein the DL reference signal configuration consists of two CSI-RS resource sets:
a. a first CSI-RS resource set consists of M CSI-RS resources (associated with the Set A of beams), and
b. a second CSI-RS resource set consists of N CSI-RS resources (associated with the Set B of beams).

8. The method of Example 6 above, wherein the second CSI-RS resource set is a subset of the first CSI-RS resource set.

9. The method of Example 6 above, wherein there is a link between the two CSI-RS resource sets, and where the link indicates that the same network node's 16 beam will be used for a CSI-RS resource when the CSI-RS resource is transmitted as part of the first CSI-RS resource set as when the same CSI-RS resource is transmitted as part of the second CSI-RS resource set.

10. The method of Example 8 above, wherein the link is explicitly configured per CSI-RS resource set (for example a field can be configured per CSI-RS resource set, and the CSI-RS resource set that is configured with the same field are linked together).

11. The method of Example 8 above, wherein the link is configured by field directly in the CSI report configuration.

12. The method of Example 8 above, where the CSI report configuration consists of two Report settings (i.e., CSI-ReportConfig as specified in, for example, 3GPP TS 38.311), where each Report setting points at one CSI-RS resource set each, and where a parameter/flag is configured per Report setting, and when the two Report settings are configured with the same parameter/flag, the two CSI-RS resource sets associated with the two Report settings are assumed to be linked together.

13. The method of Example 6 above, where the link is explicitly configured in a Resource Setting (i.e., CSI-ResourceConfig as specified in, for example, 3GPP TS 38.311).

14. The method of Example 4 above, where there is an explicit indication linking the two CSI-RS resource sets together.

15. The method of Example 4 and/or 11 above, where the is an explicit indication linking a CSI-RS resource in the first CSI-RS resource set with a CSI-RS resource in the second CSI-RS resource set.

16. The method of Example 12 above, where a link between a CSI-RS resource in the first CSI-RS resource set and a CSI-RS resource in a second CSI-RS resource set indicates that the same network node′ 16 beam is used for both CSI-RS resources.

17. The method of Example 13 above, where the CSI-RS resource in the first CSI-RS resource set and the CSI-RS resource in the second CSI-RS resource set is the same CSI-RS resource.

18. The method of Example 13 above, where the CSI-RS resource in the first CSI-RS resource set and the CSI-RS resource in the second CSI-RS resource set are different CSI-RS resources.

19. The method of any of Examples 4, 11, 12, 13, 14, or 15 above, where the linking of two CSI-RS resources is explicitly configured (using a higher layer configured parameter) per CSI-RS resource, such that two CSI-RS resource with the same parameter setting are linked together.

20. The method of and of Examples 4, 11, 12, 13, 14, or 15 above, where the linking of two CSI-RS resources is explicitly configured in a table/list, where the table/list consists of pairs of CSI-RS resources, and where the two CSI-RS resources in a pair of CSI-RS resources are linked together.

21. The method of Example 17 above, where a first CSI-RS resource of the pair of CSI-RS resources is associated with the first CSI-RS resource set, and the second CSI-RS resource of the pair of CSI.RS resources is associated with the second CSI-RS resource set.

22. The method of any of Examples 4, 11, 12, 13, 14, 15, 16, 17, and 18 above, where the linking of two CSI-RS resources can be dynamically indicated using for example DCI and/or MAC-CE.

23. The method of 1 Example 9 above, where a bitfield in DCI used to trigger the transmission of the CSI-RS resource set is used to indicate which of the CSI-RS resource(s) the wireless device 22 should perform measurements on (i.e., indicates the Set B of beams).

24. The method of any of the Examples above, where the first and second CSI-RS resource set have the same time domain behavior (e.g., both CSI-RS resource sets are periodically transmitted).

25. The method of any of the Examples above, where the first and second CSI-RS resource sets have different time domain behavior (e.g., a first CSI-RS resource set are periodically transmitted, and the second CSI-RS resource set is aperiodically transmitted).

26. The method of Example 1 above, where the DL reference signal configuration consists of a single CSI-RS resource set, consisting of M CSI-RS resources (associated with the Set A of beams).

27. The method of Example 23 above, where the CSI report configuration indicates which of the CSI-RS resource(s) in the CSI-RS resource set the wireless device 22 should perform measurements on (i.e., indicates the Set B of beams).

28. The method of Example 24 above, where the CSI report configuration consists of a single Report setting (i.e., CSI-ReportConfig as specified in, for example, 3GPP TS 38.311), and which of the CSI-RS resource(s) in the CSI-RS resource set the wireless device 22 should perform measurements on (i.e., the Set B of beams) is explicitly indicated in the Report setting.

29. The method of Example 23 above, where the DL reference signal configuration indicates which of the CSI-RS resource(s) in the CSI-RS resource set the wireless device 22 should perform measurements on (i.e., indicates the Set B of beams).

30. The method of Example 26 above, where the indication is explicitly configured in a Resource Setting (i.e., CSI-ResourceConfig as specified in, for example, 3GPP TS 38.311).

31. The method of Example 26 above, where the indication is explicitly configured in the CSI-RS resource set.

32. The method of Example 1 above, where the DL reference signal configuration consists of a single CSI-RS resource set, consisting of N CSI-RS resources (associated with the Set B of beams).

33. The method of Example 29 above, where the CSI report configuration indicates the CSI-RS resource(s) that should be used for reporting (i.e., the CSI-RS resource associated with the Set A of beams).

34. The method of Example 30 above, where the CSI report configuration consists of a single Report setting (i.e., CSI-ReportConfig as specified in, for example, 3GPP TS 38.311), and the indication is explicitly indicated in the Report setting.

35. The method of Example 1 above, where the wireless device 22 receives beam assistance information (1c) that indicates spatial correlation and/or QCL relation between one or more of the beams (CSI-RS resources) of the Set A of beams.

36. The method of Example 32 above, where the wireless device 22 use the beam assistance information as input to the AI/ML model when predicting a beam from the Set A of beams based on measurements on Set B of beams.

37. The method of Example 1 above, where the steps associated Set B transmissions (1h, 1i and 1j) are performed more frequently than steps associated with Set A transmissions (1e, 1f and 1g).

38. The method of any of the Examples above, where the first and second CSI-RS resource sets are determined by the network node 16 using the assistance information in 3.

The method of Example 1 above, where the reported predicted measurements have an associated uncertainty. The uncertainty can include probability of each respective reference signal to be best (strongest).

The following is a nonlimiting list of example embodiments.

Embodiment A1. A network node configured to communicate with a wireless device (WD), the network node configured to, and/or comprising a radio interface and/or comprising processing circuitry configured to:
transmit to the wireless device a downlink, DL, a reference signal configuration, the configuration corresponding to at least a first and second set of reference signal resources, the first and second sets being at least partially overlapping; and
communicate with the wireless device according to a preferred subset of reference signals of the first set of reference signals, the preferred subset of reference signals being selected in part based on the second set of reference signals.

Embodiment A2. The network node of Embodiment A1, wherein the reference signal configuration comprises at least one of quasi co-located type D relationship and a spatial transmitter filter.

Embodiment A3. The network node of Embodiment A1, wherein the network node is configured to, and/or comprises a radio interface and/or comprises processing circuitry configured to transmit a trigger on the preferred subset of reference signals to cause the wireless device to perform at least one measurement relating to the second set of reference signals.

Embodiment B1. A method implemented in a network node, the method comprising:
transmitting to the wireless device a downlink, DL, a reference signal configuration, the configuration corresponding to at least a first and second set of reference signal resources, the first and second sets being at least partially overlapping; and
with the wireless device according to a preferred subset of reference signals of the first set of reference signals, the preferred subset of reference signals being selected in part based on the second set of reference signals.

Embodiment B2. The method of Embodiment B1, wherein the reference signal configuration comprises at least one of quasi co-located type D relationship and a spatial transmitter filter.

Embodiment B3. The method of Embodiment B1, further comprising transmitting a trigger on the preferred subset of reference signals to cause the wireless device to perform at least one measurement relating to the second set of reference signals.

Embodiment C1. A wireless device (WD) configured to communicate with a network node, the WD configured to, and/or comprising a radio interface and/or processing circuitry configured to:
receive a downlink, DL, reference signal configuration, the configuration corresponding to at least a first and second set of reference signal resources, the first and second sets being at least partially overlapping;
perform at least one measurement of at least one reference signal of the second set; and
determine, based at least in part on the measurement, a preferred subset of reference signals of the first set of reference signals.

Embodiment C2. The WD of Embodiment C1, wherein the reference signal configuration comprises at least one of quasi co-located type D relationship and a spatial transmitter filter.

Embodiment C3. The WD of Embodiment C1, wherein the wireless device is configured to, and/or comprises a radio interface and/or comprises processing circuitry configured to perform the at least one measurement relating to the second set of reference signals in response to receiving a trigger.

Embodiment D1. A method implemented in a wireless device (WD), the method comprising:
receiving a downlink, DL, reference signal configuration, the configuration corresponding to at least a first and second set of reference signal resources, the first and second sets being at least partially overlapping;
performing at least one measurement of at least one reference signal of the second set; and
determining, based at least in part on the measurement, a preferred subset of reference signals of the first set of reference signals.

Embodiment D2. The method of Embodiment D1, wherein the reference signal configuration comprises at least one of quasi co-located type D relationship and a spatial transmitter filter.

Embodiment D3. The method of Embodiment D1, wherein the performing of the at least one measurement relating to the second set of reference signals is in response to receiving a trigger.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| 3GPP | 3rd Generation Partnership Project |
| 5G | Fifth Generation |
| ACK | Acknowledgement |
| AI | Artificial Intelligence |
| AoA | Angle of Arrival |
| CORESET | Control Resource Set |
| CSI | Channel State Information |
| CSI-RS | CSI Reference Signal |
| DCI | Downlink Control Information |
| DoA | Direction of Arrival |
| DL | Downlink |
| DMRS | Downlink Demodulation Reference Signals |
| FDD | Frequency-Division Duplex |
| FR2 | Frequency Range 2 |
| HARQ | Hybrid Automatic Repeat Request |
| ID | identity |
| gNB | gNodeB |
| MAC | Medium Access Control |
| MAC-CE | MAC Control Element |
| ML | Machine Learning |
| NR | New Radio |
| NW | Network |
| OFDM | Orthogonal Frequency Division Multiplexing |
| PBCH | Physical Broadcast Channel |
| PCI | Physical Cell Identity |
| PDCCH | Physical Downlink Control Channel |
| PDSCH | Physical Downlink Shared Channel |
| PRB | Physical Resource Block |
| QCL | Quasi co-located |
| RB | Resource Block |
| RRC | Radio Resource Control |
| RSRP | Reference Signal Strength Indicator |
| RSRQ | Reference Signal Received Quality |
| RSSI | Received Signal Strength Indicator |
| SCS | Subcarrier Spacing |
| SINR | Signal to Interference plus Noise Ratio |
| SSB | Synchronization Signal Block |
| RL | Reinforcement Learning |
| RS | Reference Signal |
| Rx | Receiver |
| TB | Transport Block |
| TDD | Time-Division Duplex |
| TCI | Transmission configuration indication |
| TRP | Transmission/Reception Point |
| Tx | Transmitter |
| UE | User Equipment |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node and to predict at least reference signals, RSs, associated with the network node, the WD being configured to:
receive a downlink, DL, RS configuration for configuring two or more sets of reference signal resources, the DL RS configuration including a first configuration for a first set of beams and a second configuration for a second set of beams, the second set of beams being a subset of the first set of beams;
receive a CSI report configuration associated with the DL reference signal configuration;
receive a first message requesting the WD to measure, according to the CSI report configuration, on a subset of DL RSs of a first set of DL RSs associated with the first set of beams;
perform measurements on a subset of DL RSs of a second set of DL RSs associated with the second set of beams;
perform one or more actions associated with an artificial intelligence model using at least the measurements on the subset of DL RSs of the second set of DL RSs;
predict one or more DL RSs from the first set of DL RSs associated with the first set of beams based in part on the one or more actions; and
transmit, to the network node, information about the predicted one or more RSs.

2.-12. (canceled)

13. A method in a wireless device, WD, configured to communicate with a network node and to predict at least reference signals, RSs, associated with the network node, the method comprising:
receiving a downlink, DL, RS configuration for configuring two or more sets of reference signal resources, the DL RS configuration including a first configuration for a first set of beams and a second configuration for a second set of beams, the second set of beams being a subset of the first set of beams;
receiving a CSI report configuration associated with the DL reference signal configuration;
receiving a first message requesting the WD to measure, according to the CSI report configuration, on a subset of DL RSs of a first set of DL RSs associated with the first set of beams;
performing measurements on a subset of DL RSs of a second set of DL RSs associated with the second set of beams;
performing one or more actions associated with an artificial intelligence model using at least the measurements on the subset of DL RSs of the second set of DL RSs;
predicting one or more DL RSs from the first set of DL RSs associated with the first set of beams based in part on the one or more actions; and
transmitting, to the network node, information about the predicted one or more RSs.

14. The method of claim 13, wherein the method further includes:
receiving a second message requesting the WD to measure the first set of DL RSs, the first set of DL RSs being transmitted less often than the second set of DL RSs.

15. The method of claim 13, wherein the method further includes:
performing collection of data associated with performance of the prediction of the one or more DL RSs from the first set of DL RSs based on measurements on the second set of DL RSs.

16. The method of claim 13, wherein the method further includes:
transmitting, to the network node, a capability indication indicating one or more of:
prediction support;
support for a spatial predicted beam report for predicting one or both of beams from the first set of beams and reference signals from the first set of RSs;
a first maximum number of one or both of beams of the first set of beams and DL RSs of the first set of DL RS;
a second maximum number of one or both of beams of the second set of beams and DL RSs of the second set of DL RS;
a minimum number of one or both of beams of the second set of beams and DL RSs of the second set of DL RS;
a machine learning, ML, model processing capability associated with the artificial intelligence model; and
prediction performance for one or more combinations of the first set of DL RSs and the second set of DL RSs.

17. The method of claim 13, wherein the method further includes:
transmitting, to the network node, a third message including uplink, UL, assistance information, the UL assistance information including one or more of:
WD location information;
an estimate of one or both of WD velocity and WD rotation;
information about WD antenna panels; and
information about WD antenna panels configuration usage.

18. The method of claim 13, wherein the DL RS configuration includes two CSI-RS resource sets, the two CSI-RS resource sets including:
a first CSI-RS resource set having M CSI-RS resources associated with the first set of beams; and
a second CSI-RS resource set having N CSI-RS resources associated with the second set of beams.

19. The method of claim 18, wherein one or more of:
the second CSI-RS resource set is a subset of the first CSI-RS resource set;
the first CSI-RS resource set and the second CSI-RS resource set are linked via a link, the link indicating that a same beam from the network node is to be used for a CSI-RS resource when the CSI-RS resource is transmitted as part of the first CSI-RS resource set as when the CSI-RS resource is transmitted as part of the second CSI-RS resource set;
the link is explicitly configured per CSI-RS resource set; and
the link is configured by field in the CSI report configuration.

20. The method of claim 18, wherein one or more of:
the CSI report configuration includes two report settings, each report setting pointing at one CSI-RS resource set each, a parameter being configured per report setting, and when the two report settings are configured with the same parameter, the two CSI-RS resource sets associated with the two report settings are assumed to be linked together;
the link is explicitly configured in one resource setting;
an explicit indication links the two CSI-RS resource sets together;
the CSI-RS resource in the first CSI-RS resource set and the CSI-RS resource in the second CSI-RS resource set is one of the same CSI-RS resource and a different CSI-RS resource;
the link of two CSI-RS resources is explicitly configured per CSI-RS resource;
the link of two CSI-RS resources is explicitly configured explicitly configured in a table;
the link of two CSI-RS resources is dynamically indicated; and
the first and second CSI-RS resource set have one of the same time domain behavior and different time domain behavior.

21. The method of claim 13, wherein:
the DL RS configuration includes:
a first single CSI-RS resource set having M CSI-RS resources associated with the first set of beams; or
a second single CSI-RS resource set having N CSI-RS resources associated with the second set of beams; and
one or both of:
the CSI report configuration indicates CSI-RS resources in the CSI-RS resource set the WD is to measure; and
DL RS configuration indicates which CSI-RS resources in the CSI-RS resource set the WD is to measure.

22. The method of claim 13, wherein the method further includes:
receiving beam assistance information indicating a spatial correlation and a quasi co-collocation, QCL, relation between one or more of beams of the first set of beams, the beam assistance information being usable as an input to the artificial intelligence model.

23. The method of claim 13, wherein the method further includes:
predicting one or more set of beams from the first set of beams based in part on the one or more actions; and
transmitting, to the network node, information about the predicted one or more sets of beams.

24. The method of claim 13, wherein the one or more actions include one or more of:
training the artificial model;
retraining the artificial model; and
updating the artificial model.

25. A network node configured to communicate with a wireless device, WD, configured to predict at least reference signals, RSs, associated with the network node, the network node being configured to:
transmit a downlink, DL, RS configuration for configuring two or more sets of reference signal resources, the DL RS configuration including a first configuration for a first set of beams and a second configuration for a second set of beams, the second set of beams being a subset of the first set of beams;
transmit a CSI report configuration associated with the DL reference signal configuration;
transmit a first message requesting the WD to measure, according to the CSI report configuration, on a subset of DL RSs of a first set of DL RSs associated with the first set of beams;
receive, from the WD, information about the one or more RSs that are predicted from the first set of DL RSs associated with the first set of beams based in part on one or more WD actions, the one or more WD actions being associated with an artificial intelligence model and being performed using at least measurements on the subset of DL RSs of the second set of DL RSs; and
perform one or more network node actions based on the information about the one or more RSs that are predicted from the first set of DL RSs.

26.-35. (canceled)

36. A method in a network node configured to communicate with a wireless device, WD, configured to predict at least reference signals, RSs, associated with the network node, the method comprising:
transmitting a downlink, DL, RS configuration for configuring two or more sets of reference signal resources, the DL RS configuration including a first configuration for a first set of beams and a second configuration for a second set of beams, the second set of beams being a subset of the first set of beams;
transmitting a CSI report configuration associated with the DL reference signal configuration;
transmitting a first message requesting the WD to measure, according to the CSI report configuration, on a subset of DL RSs of a first set of DL RSs associated with the first set of beams;
receiving, from the WD, information about the one or more RSs that are predicted from the first set of DL RSs associated with the first set of beams based in part on one or more WD actions, the one or more WD actions being associated with an artificial intelligence model and being performed using at least measurements on the subset of DL RSs of the second set of DL RSs; and
performing one or more network node actions based on the information about the one or more RSs that are predicted from the first set of DL RSs.

37. The method of claim 36, wherein the method further includes:
transmitting a second message requesting the WD to measure the first set of DL RSs, the first set of DL RSs being transmitted less often than the second set of DL RSs.

38. The method of claim 36, wherein the method further includes:
receiving, from the WD, a capability indication indicating one or more of:
prediction support;
support for a spatial predicted beam report for predicting one or both of beams from the first set of beams and reference signals from the first set of RSs;
a first maximum number of one or both of beams of the first set of beams and DL RSs of the first set of DL RS;
a second maximum number of one or both of beams of the second set of beams and DL RSs of the second set of DL RS;
a minimum number of one or both of beams of the second set of beams and DL RSs of the second set of DL RS;
a machine learning, ML, model processing capability associated with the artificial intelligence model; and
prediction performance for one or more combinations of the first set of DL RSs and the second set of DL RSs.

39. The method of claim 36, wherein the method further includes:
transmitting, to the network node, a third message including uplink, UL, assistance information, the UL assistance information including one or more of:
WD location information;
an estimate of one or both of WD velocity and WD rotation;
information about WD antenna panels; and
information about WD antenna panels configuration usage.

40. The method of claim 36, wherein the DL RS configuration includes two CSI-RS resource sets, the two CSI-RS resource sets including:
a first CSI-RS resource set having M CSI-RS resources associated with the first set of beams; and
a second CSI-RS resource set having N CSI-RS resources associated with the second set of beams.

41. The method of claim 40, wherein one or more of:
the second CSI-RS resource set is a subset of the first CSI-RS resource set;
the first CSI-RS resource set and the second CSI-RS resource set are linked via a link, the link indicating that a same beam from the network node is to be used for a CSI-RS resource when the CSI-RS resource is transmitted as part of the first CSI-RS resource set as when the CSI-RS resource is transmitted as part of the second CSI-RS resource set;
the link is explicitly configured per CSI-RS resource set; and
the link is configured by field in the CSI report configuration.

42.-46. (canceled)
